(19) United States
(12) Patent Application Publication
(10) Pub. No.: US 2008/0228664 A1
(43) Pub. Date: Sep. 18, 2008

(54) BUNDLING METHOD AND SYSTEM FOR CREDITS OF AN ENVIRONMENTAL COMMODITIES EXCHANGE

(76) Inventors: Philip Gotthelf, Closter, NJ (US); Nathan Guedalia, Fort Lee, NJ (US)

Correspondence Address: ADELI & TOLLEN, LLP, 1875 CENTURY PARK EAST, SUITE 1360, LOS ANGELES, CA, 90067, US

(21) Appl. No.: 12/047,295

(22) Filed: Mar. 12, 2008

Related U.S. Application Data
(60) Provisional application No. 60/894,380, filed on Mar. 12, 2007.

(51) Int. Cl. G06Q 30/00; G06Q 10/00

(52) U.S. Cl. 705/36 R; 705/37

(57) ABSTRACT

Some embodiments of the invention provide a method of automatically bundling environmental conservation items with computed environmental conservation values into “credit blocks” so that the aggregate sum of the environmental conservation values of the items in a particular block is sufficient to issue a tradable environmental commodity, also referred to as a credit. In some such embodiments the various different items represent items with different forms of environmental conservation such as emissions reductions, energy savings, hazardous waste reductions, or generated renewable energy.

In some embodiments, credits with at least one expired item are unbundled and the at least one expired item is removed from the credit block. Some embodiments replace the at least one expired item with at least one valid item having the same or a similar environmental conservation value.

### CLAIM OF BENEFIT TO PRIOR APPLICATION

This application claims benefit to U.S. Provisional Patent Application 60/894,380, filed Mar. 12, 2007. This United States Provisional Patent Application is incorporated herein by reference.

### FIELD OF THE INVENTION

The present invention relates to an environmental commodities exchange system and method. Specifically, to a method and system for bundling partial contributions in order to achieve a standard or uniform amount of environmental conservation.

### BACKGROUND OF THE INVENTION

Environmental regulations and stricter emissions controls are being advocated throughout various jurisdictions and countries in response to ever increasing concern over global warming. Global warming relates to the phenomenon in which an increase of carbon dioxide and other greenhouse gases within the Earth's atmosphere trap additional heat from the sun within the atmosphere causing climate change.

Several proposals have been set forth to curtail and reduce carbon and greenhouse emissions. One such proposal is set forth within the Kyoto Protocol, a 1997 international treaty that began taking effect in 2005. The Kyoto Protocol creates a commodities market in which allowances for emissions referred to as Carbon Credits, are purchased, sold, and traded.

Under the Kyoto Protocol, a central authority such as a governmental agency sets forth a limit for the amount of emissions that can be emitted by businesses and industries within the agency's jurisdiction. The stated goal to reduce emissions from the atmosphere involves creating incentives for and promoting emissions reducing business practices by providing a specified allotment of emissions allowances to these particular businesses and industries. Those businesses, industries, and even countries with efficient and environmental friendly operating practices can sell their unused allotment of Carbon Credits to other businesses, industries, and countries that have exceeded their allotment of emissions allowances. In this manner, heavy polluters can offset their excessive polluting activities by purchasing additional Carbon Credits or can improve their business practices to leave a smaller environmental footprint via more environmental friendly processes or manufacturing.

Some emissions reducing exchange models allow for the generation of new credits based on a set of standards that measure the emissions reductions provided by various products, projects, or technologies. Once the emissions reductions provided by such products, projects, or technologies reach a specified amount, a Carbon Credit is issued. The Acid Rain Program of the 1990 Clean Air Act in the United States is an example of a functioning emissions trading system for reducing sulfur dioxide (SOX) from the atmosphere.

There currently exist exchange systems for trading Carbon Credits (e.g., the Chicago Climate Exchange (CCX)). However, the functionality of these exchanges remains outside the reach of common consumers and small entities. In order to issue a tradable Carbon Credit within the CCX and other established exchanges, one must typically accumulate the equivalent of one metric ton of carbon emissions reduction or its equivalent. As a result, individual consumer purchases and small scale emissions reducing projects cannot become participants in the exchange. As such, these potential participants are dissuaded and in some instances restricted from participating in the emissions reducing market.

Therefore, there is a need for a comprehensive exchange system whereby participants of any size can participate. There is a need for the exchange system to reward participants of all qualities and quantities while still maintaining a widely-accepted definition for the trading commodity. Furthermore, there is a need for a scalable exchange system to accommodate various forms of environmental tradable commodities and credits. For example, in addition to creating credits for and providing a platform for emissions reductions, the exchange system should include: (1) tradable commodities that represent amounts of energy conservation associated with the use or application of newly developed products, projects, and technologies, (2) tradable commodities that represent amounts of properly disposed of or recycled hazardous materials and waste, (3) tradable commodities that represent quantifiable amounts of newly generated renewable energy. The exchange system should further scale to account for any new types of emissions, energy savings, hazardous waste and the associated products, projects, or technologies. The system should provide a level of convenience and automation thereby making the system accessible irrespective of the types of environmental tradable commodities, the sizes of the particular contributions by a user, and the knowledge of the users such that first time users are able conveniently participate in the system and are able to receive a benefit from their participation.

### SUMMARY OF THE INVENTION

Some embodiments of the invention provide various methods and systems for the bundling of environmental conservation items to issue one or more tradable environmental commodities, also referred to as credits. The items produce quantified amounts of environmental conversation represented by environmental conservation values. The corresponding environmental conservation values are automatically bundled into “credit blocks” so that the aggregate sum of the environmental conservation values of the items in a particular block is sufficient to issue as a tradable environmental commodity.

If the environmental conservation value of the credit block meets or exceeds a predefined or standardized comparison value, then a credit is issued on behalf of the items comprising the credit block. Some embodiments distribute a compensable value to each registrant of an item associated with the issuing credit based on the environmental conservation value contribution of each registrant to the formation of the credit block that yields the credit. However, if the environmental conservation value of the credit block is insufficient to reach the necessary environmental conservation value for issuing a credit, some embodiments aggregate one or more additional items with computed environmental conservation values to the credit block until the aggregate environmental conservation value of the credit block is sufficient to issue a credit.

Some embodiments place lifecycle restrictions on the various items included within the credit blocks. Each item has a useful lifespan during which time it may be combined with other items to form the credit blocks and issue the tradable credits. In some embodiments, credits with at least one expired item are unbundled and the at least one expired item is removed from the credit block. The at least one expired item is replaced with at least one valid item having the same or a similar environmental conservation value in order to reissue the credit for an additional term. In this manner, some embodiments are able to issue credits with perpetual lifecycles as the entire credit is never expired; only the individual components comprising the credit are expired and replaced.

Some embodiments adapt the bundling functionality to allow registrants to directly receive a benefit from their own registered amounts of environmental conservation without issuing credits based on the registered amounts of environmental conservation. Specifically, some embodiments bundle all environmental conservation values associated with the registrations of a particular registrant. The registrant may then subsequently withdraw from his/her individually bundled environmental conservation in order to directly offset some polluting activity without having to purchase credits.

Additionally, some embodiments perform buyer bundling to permit a buyer the ability to purchase only a portion or percentage of a credit by bundling several buyers into “buyer blocks”. Each buyer within a buyer block desires to offset its polluting activities, where the polluting activities of each buyer equates to only a fraction of the total pollution offsetting afforded by a single credit. In some such embodiments, the aggregate of all buyers in the buyer block exhausts the full pollution offsetting potential of the credit. Moreover, the cost for purchasing the credit is distributed amongst the buyers of the buyer block in proportion to their desired participation in the purchase of the credit.

Furthermore, some embodiments provide distributed bundling by allocating a fractional portion of an environmental conservation value produced from a registered item to at least two separate entities. For instance, when an item is used in a credit block and a compensable sum is determined for the amount of environmental conservation contributed to the overall composition of the block, the registrant or consumer of the item receives a large fractional share of the compensation while the manufacturer of the item receives a smaller fractional share of the compensable value.

### BRIEF DESCRIPTION OF THE DRAWINGS

FIG. 1 illustrates the automated bundling of items of the same type into a credit block in order to aggregate a sufficient amount of environmental conservation for issuing a tradable environmental commodity credit.

FIG. 2 presents an illustration of the bundling of items of different types and different amount of environmental conservation in accordance with some embodiments of the invention.

FIG. 3 illustrates the unbundling of a credit block that includes one or more items that have exceeded their useful life in order to bundle the remaining valid items within the credit block with a substitute item that provides the necessary environmental conservation to reissue a credit.

FIG. 4 illustrates the bundling of buyers into “buyer blocks” in order to permit individual buyers the ability to purchase only a portion or percentage of a credit in accordance with some embodiments of the invention.

FIG. 5 illustrates distributed bundling performed by some embodiments such that a fractional portion of an environmental conservation value produced from a registered item is allocated to at least two separate entities.

FIG. 6 presents a system architecture used by some embodiments to implement the registration, qualification, quantification, valuation, bundling, and trading functionality.

FIG. 7 illustrates the formation of a credit based on the environmental conservation values of multiple items, in accordance with some embodiments of the invention.

FIG. 8 presents a process that conceptually illustrates several operations for performing the automatic and transparent bundling functionality provided by the bundling engine.

FIG. 9 illustrates the issuance of a uniform credit based on the participation of multiple parties, in accordance with some embodiments of the invention.

FIG. 10 presents an exemplary illustration for issuing credits based on credit blocks of different types of items in accordance with some embodiments of the invention.

FIG. 11 illustrates an example of the aggregation interface, in accordance with some embodiments of the invention.

FIG. 12 conceptually illustrates the unbundling and rebundling steps performed by some embodiments of the invention in order to maintain the validity of a credit.

FIG. 13 presents a process that conceptually illustrates several operations performed performed by the expiration monitor and rebundling module of the bundling engine for the unbundling and rebundling credits.

FIG. 14 conceptually illustrates the interchangeability of items within credit blocks or credits, in accordance with some embodiments of the invention.

FIG. 15 presents a process performed by a pricing engine module of the bundling engine to provide the individualized bundling operations of some embodiments.

FIG. 16 presents a process that conceptually illustrates several operations performed for bundling buyers into buyer blocks to purchase credits of uniform or standard sizes.

FIG. 17 conceptually illustrates the distribution and allocation of a credit to a buyer block, in accordance with some embodiments of the invention.

FIG. 18 illustrates distributing a fractional portion of an environmental conservation value produced by a registered item to a manufacturer of the item, in accordance with some embodiments of the invention.

FIG. 19 illustrates a computer system with which some embodiments of the invention are implemented.

### DETAILED DESCRIPTION

In the following detailed description of the invention, numerous details, examples and embodiments of the invention are set forth and described. However, it will be clear and apparent to one skilled in the art that the invention is not limited to the embodiments set forth and that the invention may be practiced without some of the specific details and examples discussed.

I. Overview

Some embodiments of the invention provide various methods and systems for the bundling of environmental conservation items to issue one or more tradable environmental commodities, also referred to as credits. The items produce quantified amounts of environmental conversation represented by environmental conservation values. The corresponding environmental conservation values are automatically bundled into “credit blocks” so that the aggregate sum of the environmental conservation values of the items in a particular block is sufficient to issue as a tradable environmental commodity.

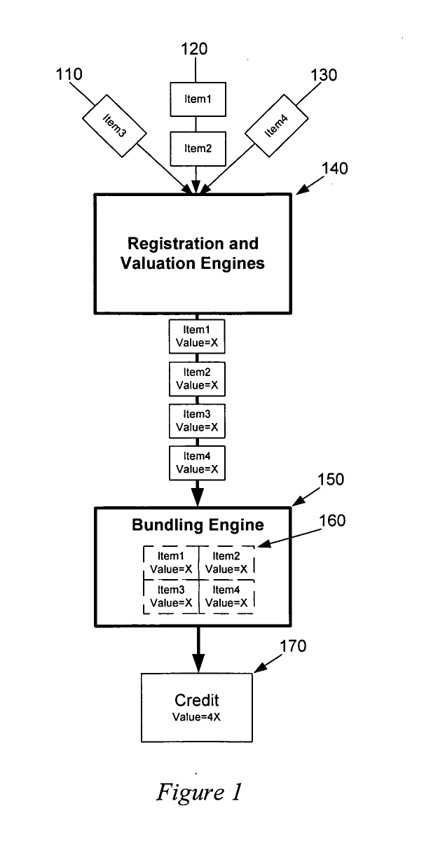

In some such embodiments, a bundling engine aggregates several of the same items with the same or similar environmental conservation values into a credit block such that the environmental conservation value of the credit block as a whole is sufficient to achieve the amount necessary for issuing a credit. FIG. 1 illustrates the automated bundling of items of the same type into a credit block in order to aggregate a sufficient amount of environmental conservation for issuing a tradable environmental commodity credit.

In this figure, various entities 110, 120, and 130 register their environmental conservation items through a registration and valuation engine 140 in accordance with some embodiments of the invention. The registration and valuation engine 140 determines an environmental conservation value to associate with each registered item. Since each item in FIG. 1 is the same, the environmental conservation values resulting from each item is the same. However, it should be apparent that in some embodiments the environmental conservation values are modified by qualification parameters that account for actual usage parameters of a user and thus the environmental conservation values computed for the same items may differ. The items and their computed environmental conservation values are then passed to a bundling engine 150.

The bundling engine 150 aggregates the items into a credit block 160 such that the environmental conservation value of the credit block 160 as a whole is sufficient to achieve the necessary environmental conservation needed for issuing a credit 170. The bundling engine 150 compares the environmental conservation value of the credit block to a standard or pre-defined value. In some embodiments, the standard or pre-defined values used to issue credits stem from governmental legislation or regulation, treaties, formal or informal agreements between parties or organizations, other environmental commodities exchange, an environmental commodities overseeing regulatory body, or a system administrator. If the environmental conservation value of the credit block meets or exceeds the necessary values for issuing a credit, then a credit is issued on behalf of the items comprising the credit block. Some embodiments distribute a compensable value to each registrant of an item associated with the issuing credit. In some embodiments, the monetary value is distributed in proportion to the environmental conservation value contribution of each registrant to the formation of the credit.

In this figure, four such items together will generate a sufficient amount of environmental conservation necessary for issuing a tradable credit. The registrants 110, 120, and 130 are then compensated proportionally based on their contributions and the market value for the issued credit 170. For instance, registrant 110 receives ¼ the value for the issued credit based on registrant's 110 ¼ contribution to the overall composition of the credit block 160 that issued the credit 170. Registrant 120 receives ½ the compensation value based on the two items registered by the registrant 120 that constituted ½ of the overall composition of the credit block 160 that issued as credit 170.

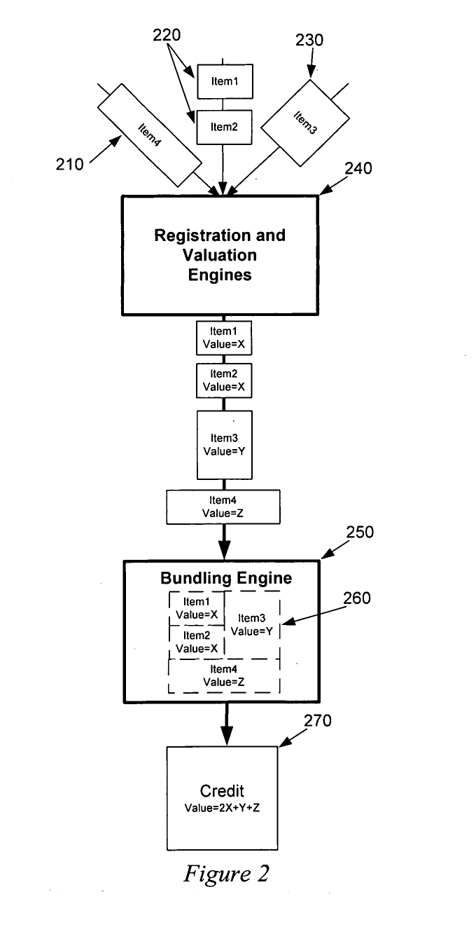

To provide greater flexibility for the bundling of items, some embodiments bundle items that produce different amounts of environmental conservation or different types of environmental conservation into a single credit block to issue as a credit. The environmental conservation provided by some such items include reductions in emissions, conservation of energy, properly disposed of hazardous wastes and materials, or generated renewable energy. FIG. 2 presents an illustration of the bundling of items of different types and different amount of environmental conservation in accordance with some embodiments of the invention.

In this figure, items 210, 220, and 230 produce different types of environmental conservation and different amounts of environmental conservation as shown by the relative sizes of the items with respect to each other. As before, the environmental conservation values for the items are determined by the registration and valuation engine 240. The bundling engine 250 determines a grouping for items 210, 220, and 230 and other items into a credit block 260 such that the aggregated environmental conservation value for the credit block 260 as a whole is sufficient to issue as a credit 270. By allowing items with different environmental conservation values and items producing different types of environmental conservation to be included within the same credit block, some embodiments increase the potential pool of items from which complete credit blocks are formed and credits are issued. In this manner, a user with an environmental conservation item, irrespective of the quality or quantity of the item's environmental conservation value, is permitted to participate and benefit from the environmental commodities exchange.

Credits and therefore the items comprising the credits contain value only so long as the environmental conservation associated with the credit and items provide an actual real-world utility. In some embodiments, the utility stems from the ability to use the environmental conservation credit to offset polluting activities that exceed regulatory controls. However, this utility is often valid for a particular duration determined by the useful lifecycle of the items comprising the credit block used to issue the credit. Therefore, some embodiments place lifecycle restrictions on the various items included within the credit blocks. Each item has a useful lifespan during which time it may be combined with other items to form the credit blocks and issue the tradable credits. Some embodiments permit the formation of credit blocks using a combination of items with different lifecycle expirations. Additionally, some embodiments provide a means whereby issued credits and the items comprising the credits are monitored and tracked for validity.

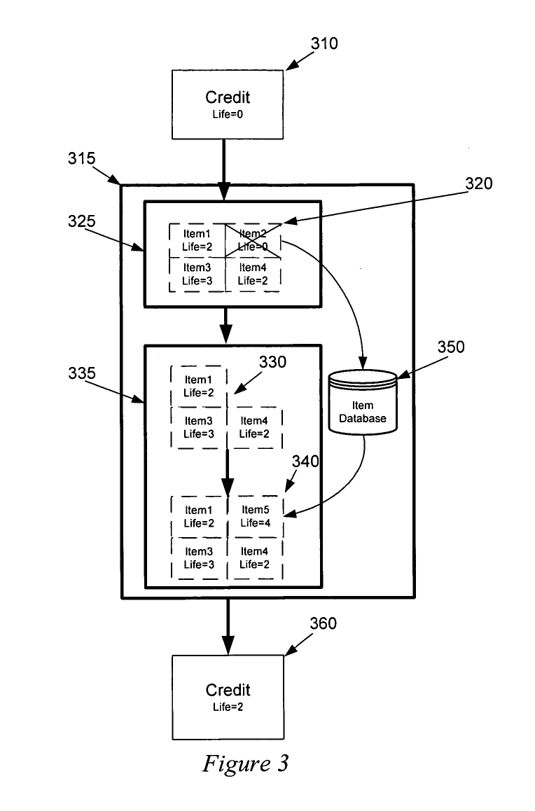

FIG. 3 illustrates the unbundling of a credit block 330 that includes one or more items that have exceeded their useful life in order to bundle the remaining valid items within the credit block with a substitute item that provides the necessary environmental conservation to reissue a credit 360. In some embodiments, the bundling engine 315 includes an expiration monitoring module 325 for identifying expiring or already expired items within a credit or corresponding credit block used in issuing the credit. As illustrated in FIG. 3, credit 310 includes one expiring or already expired item 320 identified by the expiration monitor 325.

The bundling engine 315 also includes a rebundling module 335 for unbundling and removing the expired item 320 from the credit block 330. The rebundling module 335 then replaces the at least one expired item 320 with at least one valid item 350 having the same or a similar environmental conservation value as that of the replaced item 320. The at least one valid item 350 is retrieved from an items database 340 containing valid items. In some embodiments, the expiration monitor 325 identifies the amount of environmental conservation provided by the one or more expired items to the formation of the credit block and the rebundling module 335 retrieves the one or more items from the items database 340 such that the amount of conservation provided by the retrieved items replaces the identified amount.

The newly assembled credit block then issues as a credit 360 with an updated valid lifecycle equal to that of its earliest expiring item. In this manner, some embodiments are able to issue credits with perpetual lifecycles as the entire credit is never expired; only the individual components comprising the credit are expired and replaced.

Some embodiments adapt the bundling functionality to allow registrants to directly receive a benefit from their own registered amounts of environmental conservation without issuing credits based on the registered amounts of environmental conservation. Specifically, users receive a computed environmental conservation value for each item that they register. Rather than bundle these items with other items of other users, some embodiments of the bundling engine provide a conservation engine that bundles all of the environmental conservation values associated with registrations of a particular registrant. The registrant may then subsequently withdraw from his individually bundled environmental conservation in order to offset some polluting activity without having to purchase credits. If the amount of offsetting exceeds a cumulated amount of environmental conservation for offsetting, then the user may purchase a credit in the amount of additional offsetting needed. Some embodiments allow users to purchase only fractions of a credit by bundling such buyers with other such buyers into “buyer blocks” such that the amount of offsetting requested by the buyer block exhausts the full offsetting potential provided by a credit.

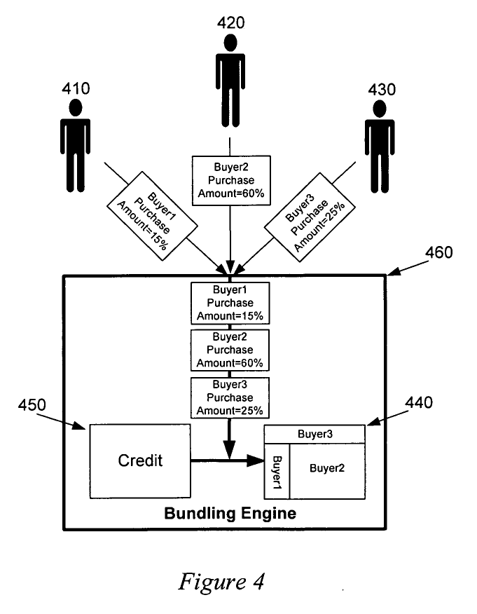

FIG. 4 illustrates the bundling of buyers into “buyer blocks” in order to permit individual buyers the ability to purchase only a portion or percentage of a credit in accordance with some embodiments of the invention. In this figure, each buyer 410, 420, and 430 within the buyer block 440 desires to offset their individual polluting activities by purchasing an environmental conservation credit 450. However, the polluting activities of each buyer 410, 420, and 430 equates to only a fraction of the total pollution offsetting afforded by the credit 450 (e.g., one ton of Carbon Dioxide emissions). As a result, the purchase of the entire credit 450 by any single buyer 410, 420, or 430 is inefficient and the cost to do so is greater than a buyer 410, 420, or 430 should be required to pay.

Therefore, some embodiments of the bundling engine 460 permit the buyers 410, 420, and 430 to specify desired amounts of a credit that they wish to purchase using a computer implemented interface provided by some embodiments. The requests are passed from the interface to the bundling engine 460. The bundling engine 460 then bundles several buyers into a buyer block 440 such that the aggregate of all buyers in the buyer block 440 exhausts the full pollution offsetting potential of the credit 450. The bundling engine 460 also distributes the cost for purchasing the credit 450 amongst all the buyers 410, 420, and 430 in proportion to their desired participation in the purchase of the credit 450. In this manner, buyers of any size, irrespective of the quantity of offsetting needed (e.g., one tenth of one ton of Carbon Dioxide pollution offsetting), can participate and benefit from the environmental commodities exchange.

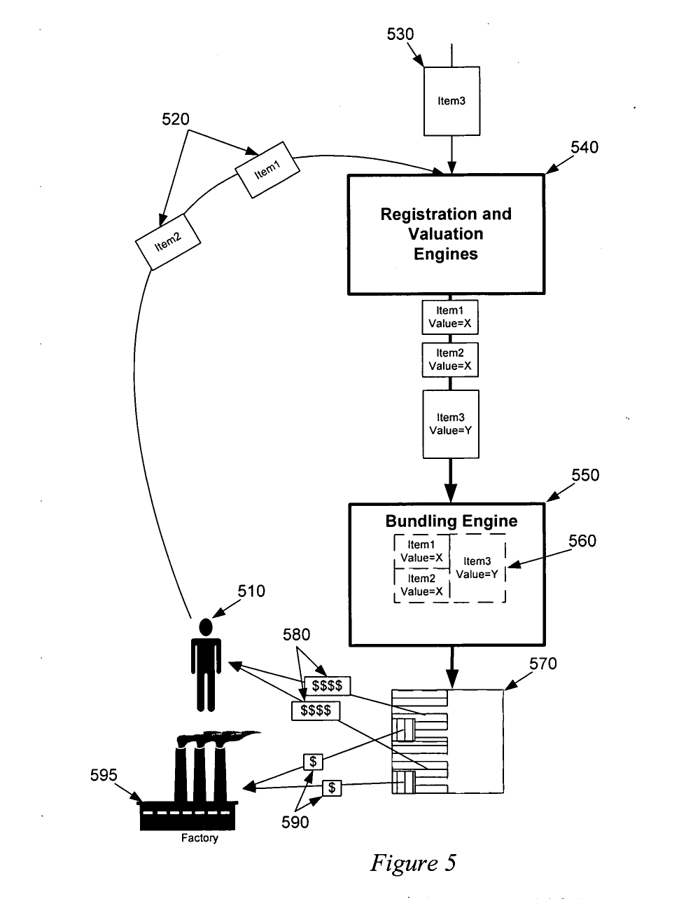

FIG. 5 illustrates distributed bundling performed by some embodiments such that a fractional portion of an environmental conservation value produced from a registered item is allocated to at least two separate entities. In this figure, a registrant 510 registers two environmental conservation items 520 and 530 using an interface provided by the registration engine 540. The registered items 520 and 530 and then submitted to the bundling engine 550 where the items are used to form credit block 560 that subsequently issues as credit 570. A pricing module of the bundling engine 550 then distributes a larger share 580 of the resulting benefit from the environmental conservation of items 520 and 530 to the registrant 510 and a lesser share of the benefit to the manufacturer 595 of the items 520 and 530.

Through the distributed bundling of some embodiments, manufacturers indirectly participate and benefit from the commodities exchange through the consumers of the manufacturer's items. Traditionally, the registrant directly receives all the benefit (e.g., monetary compensation) for the registered amount of environmental conservation. However, by providing distributed bundling, some embodiments create an incentive for manufacturers to develop and produce newer more environmentally friendly items by providing a fractional portion of the resulting benefit to the manufacturers. In this manner, manufacturers are able to recoup some of the development costs that went into producing the environmental conservation item while the registrant receiving the majority of the benefit recoups some of the higher cost that is typically associated with purchasing more environmentally friendly products relative to less efficient analogs.

Several more detailed embodiments of the invention are described in the sections below. Before describing these embodiments further, a definition as to the terms and concepts used by some embodiments is given in Section II below. This discussion is followed by the discussion in Section III of an overview of the environmental commodities exchange system architecture used by some embodiments to implement the registration, qualification, quantification, valuation, bundling, and trading functionality. Section IV describes various implementations for performing bundling. Lastly, Section V describes a computer system which implements some of the embodiments of the invention.

II. Definitions

In some embodiments, the credits are tradable environmental commodities that represent various kinds or amounts of emissions. In some embodiments, the emissions include various greenhouse gases and environmental pollutants, such as carbon dioxide, ozone, methane, nitrous oxide, sulfur dioxide, hydrofluorocarbons, perfluorocarbons, sulfur hexafluoride, various refrigerants, and other effluents into the environment. Such emissions include atmospheric and non-atmospheric emissions.

Additionally, the credits of some embodiments represent more generalized forms of energy savings, energy conservation, hazardous waste reduction, or renewable energy. For instance, credits representing reductions in the usage of energy include reductions in the usage of kilowatt hours, gas British thermal units (“BTU's”), propane, and coal as some examples. It will be apparent to one of ordinary skill in the art that various other reductions in the usage of energy are similarly covered within the scope of the invention.

In some embodiments, credits that represent some quantifiable reduction in the amount of hazardous waste or materials are provided a compensable value in the form of a municipality issued rebate or utility approved rebate when an item containing hazardous waste or materials is properly disposed of. This value is determined through the quantity and quality of the hazardous material or waste within the item. For instance, a small amount of highly radioactive material that is properly disposed of may result in a similar value as a large amount of mercury that is properly disposed of, where a proportional amount of mercury is relatively less toxic than that of the highly radioactive material.

In this manner, an incentive is created to remove such hazardous waste or materials from traditional landfills, where such toxins can contaminate the soil or seep into the water supply. For instance, the proper disposal of light bulbs or computer components containing mercury or lead, batteries containing toxic metals such as alkaline, lithium, and nickel-cadmium, and light ballasts containing polychlorinated biphenyls (PCBs) removes these toxic materials from landfills and instead moves the toxic materials to a facility where they can be properly and safely disposed of or even recycled. Moreover, the administration and oversight regarding the rebates is removed from the municipality or utility and is instead given to some embodiments where it is readily facilitated through a computer implemented interface.

It will be apparent to one of ordinary skill in the art that various other solids, liquids, contained gases, or sludges that are a result of by-products from manufacturing processes or discarded products that potentially can contaminate the soil, water supply, or cause other environmental harm are similarly covered within the scope of the invention. The Environmental Protection Agency (EPA) has issued certain lists (e.g., F-list for non-specific source wastes, K-list for source-specific wastes, P-list and U-list for discarded commercial chemical products) to cover certain recognized wastes with certain ignitable, corrosive, reactive, or toxic properties that would be applicable to some embodiments of the invention.

In some embodiments, the credits also represent standard or pre-defined amounts of generated renewable energy. Such renewable energy includes energy created from wind farms or solar farms as some examples, though renewable energy may be derived from other renewable sources such as geothermal heat, biomass, landfill waste, or by-products of farming operations.

The generated renewable energy can be sold back into the electric grid, but can also be used to determine some quantifiable amount of emissions reduction. Since, the generated renewable energy was created without producing atmospheric emissions, there is a quantifiable amount of emissions reductions attributable to the amount of generated renewable energy. Specifically, every unit of renewable energy that is created and sold back into the electric grid results in one fewer unit of energy that has to be created from traditional polluting means.

The credits of some embodiments may also take the form of rebates that are issued by municipalities or various other regulatory agencies for meeting certain criteria in environmental conservation. Such environmental conservation includes receiving rebates for the purchase and installation of a water heater with energy ratings that fall within a specified threshold or for the proper disposal of items containing hazardous materials that could otherwise harm the environment if placed within a landfill.

In some embodiments, the environmental conservation items include various products, projects, and technologies that quantifiably impact the environment to result in a measurable about of environmental conservation. In some embodiments, an environmental conservation product is a product with some less efficient or less environmentally friendly pre-existing analog. Since efficient environmental conservation products consume less energy, less energy needs to be produced. Power plants that generate the energy consumed by the products produce a certain amount of greenhouse gases with every unit of generated energy and consumed energy. Therefore, the equivalent use of a more efficient product compared to a less efficient analog product requires less energy to be produced resulting in fewer greenhouse emissions from the power plant. For instance, hybrid vehicles as opposed to traditional combustion engine vehicles consume less gasoline per mile driven. Since the combustion process for converting gasoline into energy is mainly responsible for the carbon dioxide emissions associated with automobiles, combusting less gasoline results in less carbon dioxide being released into the atmosphere. Similarly energy efficient lighting, such as compact fluorescent light bulbs as opposed to less energy efficient incandescent light bulbs, consume less electricity over their respective lifetimes to produce an equivalent amount of light. Since a unit of electricity that is consumed is typically derived from some polluting power generating process (e.g., natural gas power plants, coal fueled power plants), the fewer units of electricity consumed, the fewer the amount of pollutants produced.

Environmental conservation projects include processes such as carbon sequestering that remove or reduce atmospheric greenhouse emissions. Additionally, some projects may generate energy thereby reducing the amount of pollution associated with other power generating activities. In some embodiments, the environmental conservation associated with a project contains some overlap with products. For example, a lighting retrofit project involves replacing older inefficient light bulbs for an entire building or enterprise with newer efficient light bulbs. Such a project provides a level of environmental conservation by virtue of the products used within the product. As such, the environmental conservation associated with these projects and products may be registered only once.

Similarly, a newly developed technology without any previously existing analog that reduces energy usage, emissions, or cleanly produces energy over traditional means would have a set of associated environmental conservation properties that could be used to quantifiably compute the environmental conservation associated with the item. An example of such a technology would be a viable commercial implementation of cold fusion.

The quantifiable impact of such items is determined through the various environmental conservation properties of the items that include attributes or characteristics of the item that identify an amount of emissions reductions, energy conservation, reduction in hazardous materials/waste, or generated renewable energy associated with the use or application of the item. From the set of properties, an environmental conservation value is determined and associated with the item. In some embodiments, the environmental conservation value represents a numerical quantification of the amount of environmental conservation that results from the item over its useful life. Specifically, a typical quantifiable metric in defining the environmental conservation value for an item is to measure the amount of carbon dioxide (CO2) emissions associated with a particular item over its useful life.

The environmental conservation values are computed using one or more protocols. Protocols compute the environmental conservation values over an item's set of environmental conservation properties. Additionally, some embodiments compute the environmental conservation values based on an actual use or implementation of the device through various qualification parameters. The qualification parameters relate the actual amount of environmental conservation produced by an item to a user's usage behavior and actual energy used by the item. Different protocols may be applied to the same item to derive different environmental conservation values depending on differing regulations, jurisdictions, credit exchanges, etc. Accordingly, one or more protocols can be applied to compute the environmental conservation values of the same item. The protocols used in quantifying and valuating the environmental conservation of an item are derived from a variety of sources including international treaties, municipalities, states, federal governments, quasi-governmental regulatory bodies formed to oversee environmental regulations, or voluntary pacts between participants in the environmental commodities exchange.

When a standard or pre-defined amount of the environmental conservation value is met, either through the environmental conservation value of a single item or through multiple items, some embodiments issue a tradable environmental commodity, such as a Carbon Credit. The commodities can then be bought, sold, and traded within various environmental commodities exchanges (i.e., wholesale market) or sold to the public by means of a retail shopping cart (i.e., retail market).

The value of these issued credits stems from the ability to use the credits to offset certain amounts of pollution resulting from the credit owner's activities, whether manufacturing, transporting, or developing and the offsetting of such activities is recognized within some enforceable regulation. For instance, the Kyoto treaty created caps or quotas for the amount of carbon emissions that various countries can emit. Therefore, when a country exceeds its quota, the country is required to purchase credits to offset the extra amount of pollution generated in excess of the allotted quota. Moreover, some regulations require local utilities to either reduce their emissions production and energy consumption or use green power for a certain percentage of their business related activities. Therefore, some utilities unable to generate the green energy may simply purchase credits that represent certain amounts of generated green energy from others. Other reductions might be voluntary or contractual, based upon a corporate policy or mandate, and subject to legal enforcement. Once such example is found in the membership requirements on the Chicago Climate Exchange that requires members to adhere to scheduled emissions reductions.

Several protocol formulas for computing the environmental conservation value for various environmental conservation items will now be provided. A C.A.F.E. (Corporate Average Fleet/Fuel Economy) protocol may be used by some embodiments to compute the environmental conservation value associated with a vehicle. The formula specifies vehicle fuel savings as the difference between the mileage of the vehicle and the C.A.F.E. value. The computed fuel savings value is then converted into an environmental conservation value (ECV) using a second formula in which:

ECV=Average Annual Mileage of the Vehicle−(Fuel Savings/Product Mileage* C.A.F.E.)*Lbs. of CO2

Some embodiments provide a protocol for determining the environmental conservation value of light bulbs. The protocol converts the emissions savings of an energy efficient light bulb into an environmental conservation value using the following formula:

ECV=(Wattage Equivalence for the Energy Saving Bulb−Actual Wattage)*(Hours per Year)*Lbs of Carbon per Watt associated with a specific power generating facility (utility).

The above examples illustrate the computation of an environmental conservation value using the amount of CO2 reductions as the measurable metric. Emissions of other non-CO2 greenhouse gases can similarly be converted to metric tons of CO2 in order to calculate an environmental conservation value associated with a registered item. A recognized method is to use a CO2 equivalent such as the one hundred year Global Warming Potential (GWP) value as established by the Intergovernmental Panel on Climate Change. The GWP is based on various factors such as a particular heat-absorbing ability of a particular emitting gas also referred to as the radioactive efficiency of the gas. Therefore, protocols of some embodiments can be adapted for computing emissions reductions of credits involving non-CO2 greenhouse gases.

Moreover, it should be apparent to one of ordinary skill in the art that the protocols of some embodiments use various other measurable metrics in computing the environmental conservation value (e.g., kilowatt hours generated from a renewable energy source). It should also be apparent to one of ordinary skill in the art that the protocols of some embodiments can be adapted for computing other emissions reductions, energy savings, reductions in hazardous wastes or materials, and for valuing amounts of generated renewable energy. For example, in order to track and create a rebate for reductions in the hazardous materials of light bulbs such as mercury, some embodiments compute the environmental conservation value associated with the reduction in mercury using the following equation:

$$Mercury Content [ Picograms \text{/} Lumen Hours ] = \frac{[ {\sum }_{TypesofBulbs} ( Total mercury content per bulb type ) ]}{[ {\sum }_{TypesofBulbs} ( Total lumen hours ) ] * 10 ** 12}$$

III. Architecture

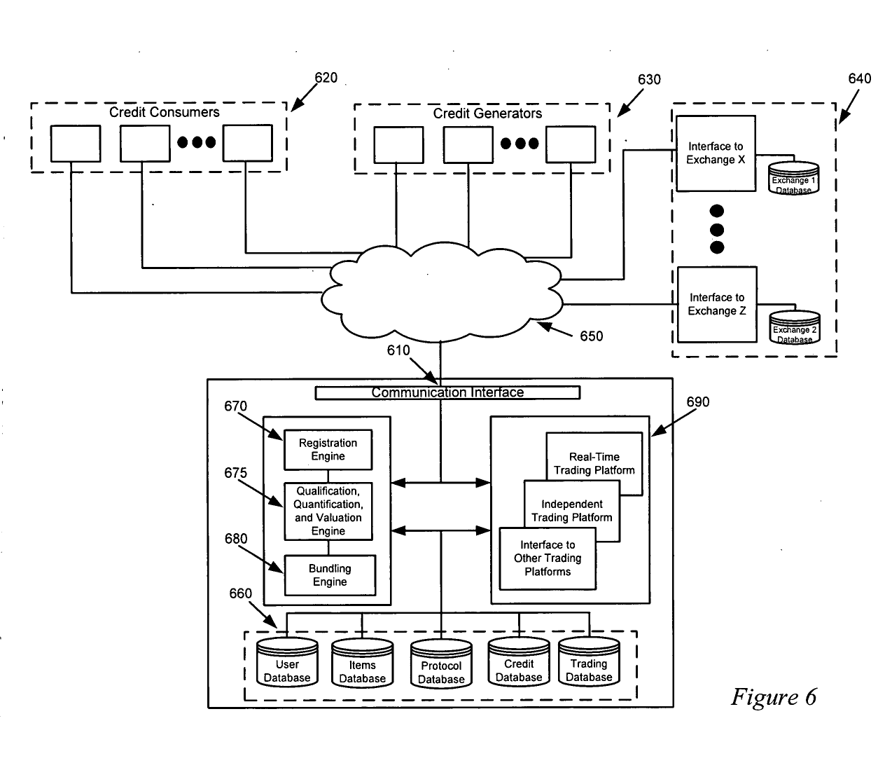

FIG. 6 presents a system architecture used by some embodiments to implement the registration, qualification, quantification, valuation, bundling, and trading functionality. As illustrated in FIG. 6, communications with the system are facilitated through a computer implemented interface 610 in which credit consumers 620, credit generators 630, and other exchanges 640 access the system through a communication medium 650. In some embodiments, the credit consumers 620 and the credit generators 630 include registrants of the environmental conservation items and the buyers and sellers participating within the trading platform. In some embodiments, the credit consumers 620 and credit generators 630 include individual consumers, groups of consumers, businesses, governmental agencies, environmental groups, and other exchanges engaged in environmental commodities trading.

In some embodiments, the communication medium 650 is any network or network of networks through which different devices access the various functionalities provided by the various engines and sub-modules of the engines described below. The communication interfaces for the communication medium 650 include the internet, plain old telephone system (POTS), wireless data services (GPRS), local area network (LAN), wide area network (WAN), or other physical or wireless communication medium. In some embodiments the communication interface 610 is implemented to provide web server functionality via some or all such interfaces. Additionally, the communication interface 610 of some embodiments is implemented using a Service Oriented Architecture (SOA). Using the SOA, some embodiments are capable of processing incoming information through two or more integrated interfaces. These interfaces include other applications, websites, or user interfaces. Additionally, in some embodiments, the various engines (e.g., registration engine, valuation engine, bundling engine, trading engine, or their respective modules) create the interfaces provided to users over the communication interface 610.

In this manner, the architecture of FIG. 6 permits credit consumers 620, credit generators 630, and the other exchanges 640 to be located anywhere throughout the world while still permitting such entities access to the services provided by the system using a variety of different communication devices such as personal digital assistants (PDAs), computers, wireless smartphones, or any internet enabled device. Accordingly, the system interface unifies all entities so that a single entity accessing the system can interact with all other entities accessing the system through a single interface regardless of its physical location throughout the world. For instance, if the entity was a credit generator, then the entity would interact with other credit generators by bundling his items with those of other credit generators.

Some embodiments of the invention store information related to registering, qualifying, quantifying, valuating, bundling, and trading in a set of databases 660. These databases 660 store information such as the available items ready for bundling, the environmental conservation properties of the items, the qualification parameters of the items, the environmental conservation values associated with the items, issued credits, the useful life of the credits, protocols used to value the environmental conservation values of the items, or general user access information as some examples. One of ordinary skill in the art will recognize that some embodiments of the invention include some, all, or additional databases 660 for storing information pertaining to the functionality provided by the system. Additionally, though the databases 660 have been shown as multiple databases, one of ordinary skill in the art will recognize that the multiple representations can be a conceptual representation and that the actual physical implementation may be conducted through a single database. The system also includes logic for querying, storing, and retrieving information from such storage locations 660 and for presenting the information through the interface 610 to the users.

Functionality within the system is provided via the various functional engines. In FIG. 6, the system includes a registration engine 670, a qualification, quantification, and valuation engine 675, a bundling engine 680, and a trading engine 690. In some embodiments, one or more of the engines represents software processes executed by a processor of a computing device. In other embodiments, one or more of the engines represents physical hardware devices that implement the functionality described herein. It should be apparent to one of ordinary skill in the art that the various other functional modules may similarly be incorporated within the overall system. These modules may act as sub-components of the various engines providing specific functionality. The functionality of some of these modules are described in the processes below.

The registration engine 670 implements the interface through which environmental conservation items are registered and administrative functionality pertaining to the management of a user account is performed (e.g., disbursing of payments and tracking of registered items). The functionality for the registration engine 670 is described in further detail in the United States Patent Application titled “Registration Method and System for an Environmental Commodities Exchange” with attorney docket EQDX.P0015 which is incorporated herein by reference. The valuation engine 675 determines an amount of environmental conservation associated with the use or application of an environmental conservation item. The functionality for the valuation engine 675 is described in further detail in the United States Patent Application titled “System and Method for Valuating Items as Tradable Environmental Commodities” with attorney docket EQDX.P0006 which is incorporated herein by reference. The bundling engine 680 provides the bundling and unbundling of fractional credits, buyers, and sellers and is described in further detail in Section IV below. The trading engine 690 provides the trading platform over which credits are bought, sold, and traded. The functionality for the trading engine 690 is described in further detail in the United States Patent Application titled “Registration Method and System for an Environmental Commodities Exchange” with attorney docket EQDX.P0015.

IV. Bundling

A. Bundling Items into Credit Blocks

In some embodiments, the bundling functionality facilitates the participation of individual consumers and other small entities in the environmental commodities exchange by permitting such entities to participate and benefit from the exchange irrespective of the quantity or quality of their respective contributions. The individual or small scale contributions of such entities together with the contributions of other such entities are grouped into credit blocks. The sum of the environmental conservation values contained within the credit block achieves the amount of environmental conservation needed for issuing a credit. In this manner, any entity with an item that results in any amount of environmental conservation is able to participate and benefit from the buying, selling, and trading of environmental conservation commodities.

Typically in other exchanges, individual registrants must contribute a specified amount of environmental conservation before being able to participate in the exchange (e.g., the registrant must individually amass one ton worth of CO2 reductions before receiving a credit). This is due to the fact that environmental credits represent standardized amounts of environmental conservation. The standardized amounts are intended to create an impact on a large commercial scale. One of the most commonly used metrics (i.e., environmental conservation value) for issuing a credit is to quantify the credit so that the credit equates to one ton worth of CO2 emissions reductions.

The bundling functionality of some embodiments permits a consumer who purchased a single environmental conservation item with a small environmental conservation value to nevertheless meet the environmental conservation value needed for issuing a standardized credit by creating credit blocks. Within the credit blocks, the environmental conservation value of a particular entity is combined with those of other similar entities in order to meet the required amounts of environmental conservation necessary for issuing a credit.

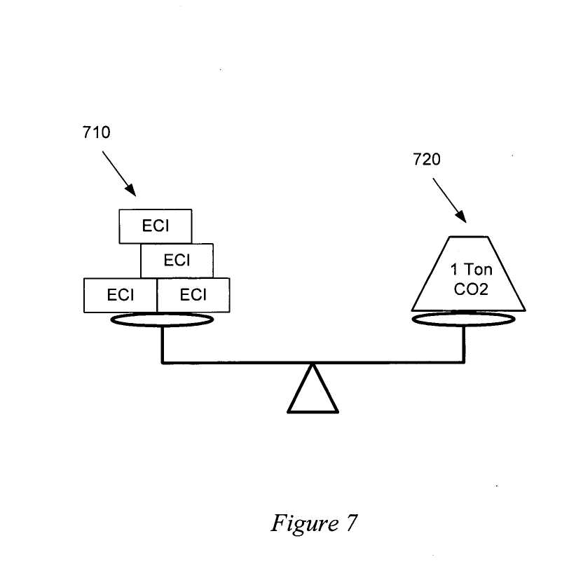

FIG. 7 conceptually illustrates the creation of a credit block. In this figure, a credit represents one ton worth of carbon emissions reduction 720. To achieve the one ton quota for issuing a credit, FIG. 7 bundles four different environmental conservation items 710 together. The sum of the environmental conservation values of these items 710 equates to the one ton of carbon emissions reduction 720 necessary for issuing a credit. In some embodiments, the bundling operation is performed automatically and transparently by a process stored on a computer readable medium that is executed by a computer processor or some other electronic device.

Once the sufficient amount of environmental conservation is reached within a credit block, a credit is issued and assigned a monetary value. In some embodiments, the monetary value is determined by market factors. Based on the determined monetary value of the credit, each registrant who contributed at least one item used within the credit block receives a proportional share or amount for his/her contribution to the overall composition of the credit.

To determine a registrant's proportional share, some embodiments identify the items used within the credit block that issued as a credit. For each identified item, the registrant for the item is identified. The total environmental conservation value from the items contributed by each registrant is computed. Some embodiments compare this individual total environmental conservation value to the overall environmental conservation value of the credit block as a whole. The comparison yields the contribution percentage for each registrant. Based on the contribution percentage, some embodiments disburse a corresponding percentage of the total monetary value of the issued credit to the registrants. For example, if the registrant's environmental conservation value contribution to the credit block represents half of the total environmental conservation value of the credit block and the prevailing market rate for a credit is $20, then that registrant will receive 50% of the total value of the credit or $10. It should be apparent to one of ordinary skill in the art that in providing the bundling functionality, some embodiments subtract a fraction of the total monetary value of the credit in return for the facilitation of the services.

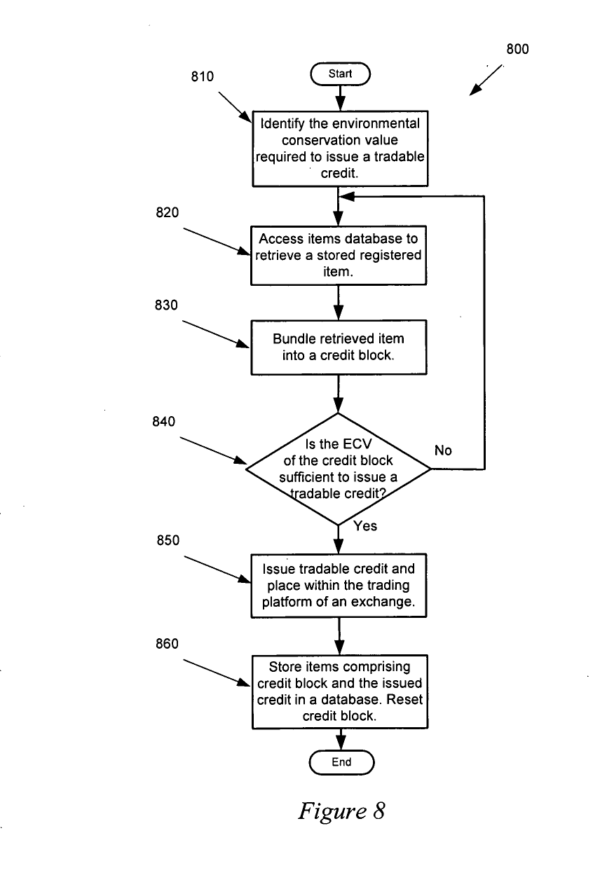

FIG. 8 presents a process 800 that conceptually illustrates several operations for performing the automatic and transparent bundling functionality provided by the bundling engine. The process 800 begins by identifying (at 810) the environmental conservation value necessary for issuing a tradable credit. In some embodiments, this value is specified within governmental legislation or regulation, treaties, formal or informal agreements between parties or organizations, another environmental commodities exchange, an environmental commodities overseeing regulatory body, or a system administrator as some examples. For example, the environmental conservation values of the Carbon Credits traded on the CCX represent one ton worth of Carbon emissions, therefore a system administrator may enter this value as the specified value of 810.

The process then searches (at 820) the items database to retrieve items that have been registered but have yet to be associated with or included within a credit block issued as a credit. Some embodiments also allow an item to be included within multiple credit blocks by including a first fractional portion of the environmental conservation value resulting from the item into a first credit block that issues as a first credit and a second fractional portion of the environmental conservation value resulting from the item into a second credit block that issues as a second credit. In some embodiments, the search (at 820) begins upon some triggering event. For example, some embodiments conduct a search when a registrant registers a new environmental conservation item that in and of itself does not result in a computed environmental conservation value sufficient for issuance of a credit.

The items that have yet to be bundled into a credit block or the items where only a fractional amount of their total environmental conservation values is already included within a credit block are appropriately marked when stored within the databases illustrated with reference to FIG. 6. In this manner, a simple and efficient query can search for a single field within the database records in order to determine which registered items are available for bundling. A more complex query can determine whether any items in the database have a specific environmental conservation value or an environmental conservation value that falls within a specified environmental conservation value range needed to complete a credit block. The process retrieves the items resulting from the query (e.g., one by one or in multiple sets) and places (at 830) the results within the credit block that contains other items or is empty.

The sum of the environmental conservation values of all items within the credit block is computed and compared (at 840) against the defined environmental conservation value of 810. Should the sum of the environmental conservation values of the credit block be deficient in its amount, the items database is again queried (at 820) for another item to be placed within the credit block. Should the sum of the environmental conservation values of the components comprising the credit block meet or exceed the defined amount of 810, then the process issues (at 850) a tradable credit and the credit is placed within the trading platform of some exchange. The items comprising the credit block that become parts of the issued credit are marked accordingly within the items database. As a result, the marked items will not be used in the subsequent construction of other credit blocks. The process also stores (at 860) the credit within the credit database and the credit block is reset.

In some embodiments, the credits issued as a result of the bundled credit blocks are bought, sold, and traded within the wholesale environmental commodities market or wholesale exchange. In other embodiments, the credits issued as a result of the bundled credit blocks are bought, sold, and traded within the retail environmental commodities market or retail exchange. Specifically, in the retail market the availability of such environmental credits is determined by an amount of such credits purchased from the wholesale market. A retailer can thus sell a credit to a consumer to use in offsetting polluting activities of the buyer.

i. Bundling Items of the Same Type

To assemble the above described credit blocks, some embodiments include the environmental conservation items of the same type within the credit block. For instance, one credit block includes only energy efficient light bulbs whereas another credit block only includes hybrid vehicles. The credit blocks of some such embodiments may have a more or less restrictive classification such that the energy efficient light bulbs within a particular credit block are manufactured only by manufacturer X or specify a luminance of Y.

Accordingly, some embodiments of the invention create a one-to-one contract between the item and an environmental commodities exchange. The contract may be satisfied in separate parts and at different times. Each time an item meeting the criterion for entry into the block is registered, that item individually satisfies a contract between the registrant and the system. The various registrants thus fulfill a contractual requirement at the time of registration even though the complete contract for issuing the credit remains incomplete. In some embodiments, contracts are automatically created whenever an item is registered. The registrant need not seek the approval of the exchange before registering an item.

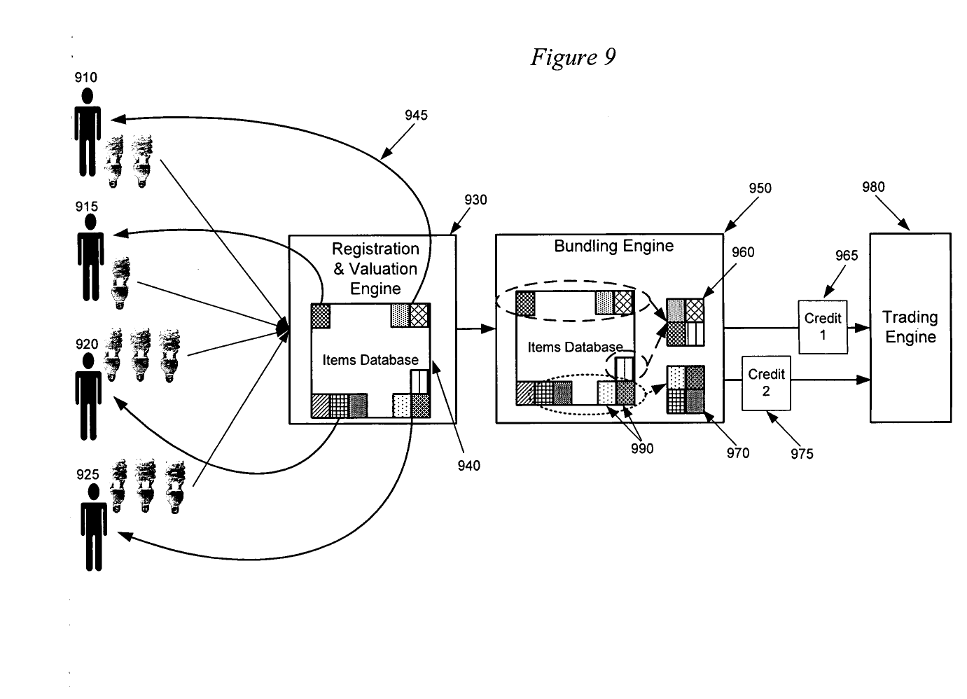

FIG. 9 illustrates the issuance of a uniform credit based on the participation of multiple entities. In FIG. 9, multiple registrants 910-925 access the system through a computer implemented registration interface provided by a registration and valuation engine of some embodiments 930. The registration interface permits each registrant to register various items, however to illustrate the bundling functionality with respect to the same or similar items, only energy efficient light bulbs (e.g., compact fluorescent light bulbs) are depicted. The registration and valuation engine 930 registers the items and creates an entry for each item within the items database 940.

The database 940 associates each registered entry with a particular registrant. For example, the two light bulbs registered by the registrant 910 contain identification information associating the entries 945 within the item database 940 to the registrant 910. Similarly, the other registered light bulbs contain information that identifies the registrant of the items.

Once entered within the items database 940, the process of issuing the credits occurs automatically and transparently to the registrants 910-925. In some embodiments, issuing credits requires that the environmental conservation value for each item be computed by associating a proper protocol to each item. In this instance, all the items are the same, therefore the registration and valuation engine 930 will utilize the same protocol to compute the environmental conservation values for each item.

In FIG. 9, a single bulb does not contain a sufficient environmental conservation value to issue a credit. Rather in this illustration, four energy efficient light bulbs are required to amass the proper environmental conservation value for issuing a credit. Based upon some triggering event, the bundling engine 950 will attempt to combine several such items together within a credit block in order to accumulate the necessary environmental conservation value for issuing a credit. The bundling engine 950 queries the items database 940 for any items that have been registered and whose environmental conservation values have yet to be associated with a credit block.

The bundling engine 950 creates a first credit block 960 including the registered items of registrants 910, 915, and 925. Since the credit block as a whole contains a sufficient aggregate environmental conservation value to issue a credit, credit 965 is issued and sent to the trading engine 980 where it is bought, sold, and traded. In some embodiments, prior to selling the credit 965 through the trading engine 980, some embodiments distribute an amount of compensation to each registrant who contributed to the composition of the credit 965. With reference to issued credit 965, each light bulb comprises 25% of the overall composition of the credit. Therefore, registrant 910 receives 50% of the amount of compensation, because registrant 910 contributed two items to the overall composition of the credit block 960 and registrants 915 and 925, each of which contributed one light bulb to the overall composition of the credit, receive 25% of the amount of compensation.

However, only one of the three light bulbs registered by registrant 925 was used in creating the first credit 965. As the environmental conservation value of the remaining two light bulbs 990 of registrant 925 only result in 50% of the needed environmental conservation value for issuing a credit, the remaining two light bulbs 990 are placed into a second credit block 970. Two additional registered but unassociated energy efficient light bulbs are identified within the items database 940 and placed within the second credit block 970. As a result, the second credit 975 is issued with registrants 920 and 925 each receiving 50% of the compensation amount.

ii. Bundling Items of Different Types or Amounts of Environmental Conservation

In some embodiments, the credit blocks include environmental conservation items that represent different types of environmental conservation or different amounts of environmental conservation. In some such embodiments, a larger pool of registered but unassociated items becomes available for bundling into the credit blocks as the credit block may include any item that has been registered within the system irrespective of the item's type or environmental conservation value. For instance, in order to achieve the necessary environmental conservation value for issuing a credit, some embodiments of the bundling engine include one or more energy efficient light bulbs, energy efficient water heaters, and hybrid vehicles within a single credit block to issue a credit that allows for a particular amount of CO2 emissions to be offset with use of the credit. It should be apparent to one of ordinary skill in the art that any environmental conservation item (e.g., product, project, or technology) can be incorporated into the credit block.

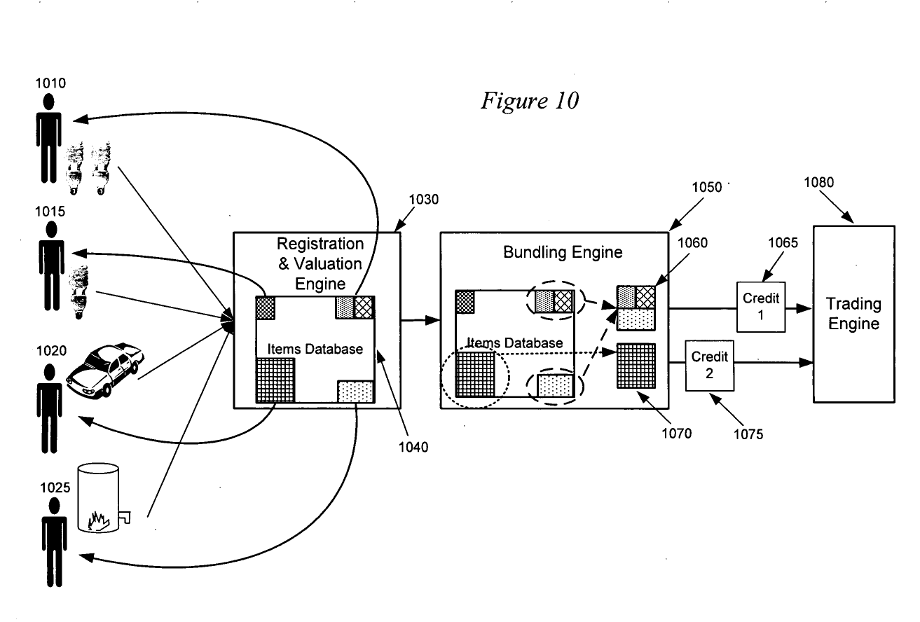

FIG. 10 presents an exemplary illustration for issuing credits based on credit blocks comprising different types of items in accordance with some embodiments of the invention. In FIG. 10, four registrants 1010-1025 each register different environmental conservation items through the registration interface of a registration and valuation engine 1030. Similar to FIG. 9, the registered items are stored within the items database 1040. However, because the items are of different types, a different protocol is used to compute the environmental conservation value for each item or item type. Therefore, the energy efficient lights bulbs of registrant 1010 will yield a different environmental conservation value than the registered hybrid vehicle of registrant 1020. The respective environmental conservation values of the registered items are conceptually represented by the size of the entries within the database 1040 of FIG. 10.

By using the environmental conservation values of the items, it becomes irrelevant what the actual items being combined within the credit blocks are. In this manner, the credits issued from the credit block still represent a standard or pre-defined amount of environmental conservation, though the credit block comprises various different items. In some embodiments, environmental conservation values representing different forms of environmental conservation can also be placed within the same credit block. For instance, a credit block may include a first environmental conservation value representing some amount of energy savings (e.g., reduction in kilowatt hours), a second environmental conservation value representing some amount of emissions reductions (e.g., reduction in emitted carbon dioxide), and a third environmental conservation value representing some amount of generated renewable energy (e.g., gallons of ethanol produced from a biofuel conversion process). Together, these three items may aggregate the necessary environmental conservation value needed to issue a tradable credit.

In FIG. 10, the bundling engine 1050 includes within the first credit block 1060 the environmental conservation resulting from the light bulbs of registrant 1010 and the environmental conservation resulting from the energy efficient water heater of registrant 1025. Though each registrant contributed to one half of the overall composition of the credit block 1060, registrant 1010 registered two items while registrant 1025 contributed a single item with a higher environmental conservation value than that of registrant 1010.

In creating the credit blocks, some embodiments of the bundling engine 1050 query the database 1040 to retrieve only those items with an environmental conservation value that is equal to or less than the amount needed to issue a credit. For instance, if a credit block included the two light bulbs of registrant 1010 that provide one half of the necessary environmental conservation value to issue a credit, then the query into the items database 1040 would become narrowed to search a subset of available but unassociated items. Specifically, the modified query would not only search for those items that have been registered but unassociated, but would include an additional query parameter to specify only those items with an environmental conservation value of one half or less than that needed to issue a credit. In this manner, the bundling engine 1050 of FIG. 10 efficiently partitions and allocates the available pool of registered items to credit blocks.

In FIG. 10, the second credit block 1070 is issued using only a single registered item. The second credit block 1070 therefore bypasses the set of bundling operations as the registered hybrid vehicle of registrant 1020 has a necessary computed environmental conservation value for issuing the second credit 1075.

In some embodiments, the environmental conservation values of some items do not always precisely fall within the available amount of the credit block. For example, an item X has an environmental conservation value of 75 units and an item Y has an environmental conservation value of 50 units, however only 100 units of the environmental conservation value are required to issue a credit. Placing items X and Y into a single credit block would issue a single credit and 25 units of the environmental conservation value of either item X or Y remain unbundled. Therefore, in some embodiments, the environmental conservation value of a single item is spread across multiple credit blocks. In this manner, a single item can be used to form one or more credits. Using the above example, 50 units of item X can be combined with the 50 units of item Y in a credit block A1 to issue a credit A2, 20 units of item X can be combined with 80 units of an item Z in a credit block B1 which issues as a credit B2, and the remaining 5 units of item X can be combined with two other items in a credit block C1, where the combined environmental conservation value of all three items in credit block C1 equates to the necessary 100 units for issuing as a credit C2. It is irrelevant whether each credit (e.g., A2, B2, or C2) is sold to different buyers as each credit, regardless of the items of its composition, represents the same environmental conservation value (e.g., 100 units of a particular environmental conservation value).

B. Expiration of Items

As credits are issued, some embodiments of the invention create an entry into a database to store and track the credits. In some embodiments, tracking is provided via associating an identification parameter to each newly created credit. Tracking is necessary for some embodiments where a tradable credit has a useful lifespan that indicates a duration in which the credit can be used to offset polluting activities. Therefore, in conjunction with or instead of the identification parameter, some embodiments associate a duration value with the credit block or issued credit to specify a useful life for the credit. Additionally, some embodiments store other properties of the credit including the various items that comprise the credit within a database record.

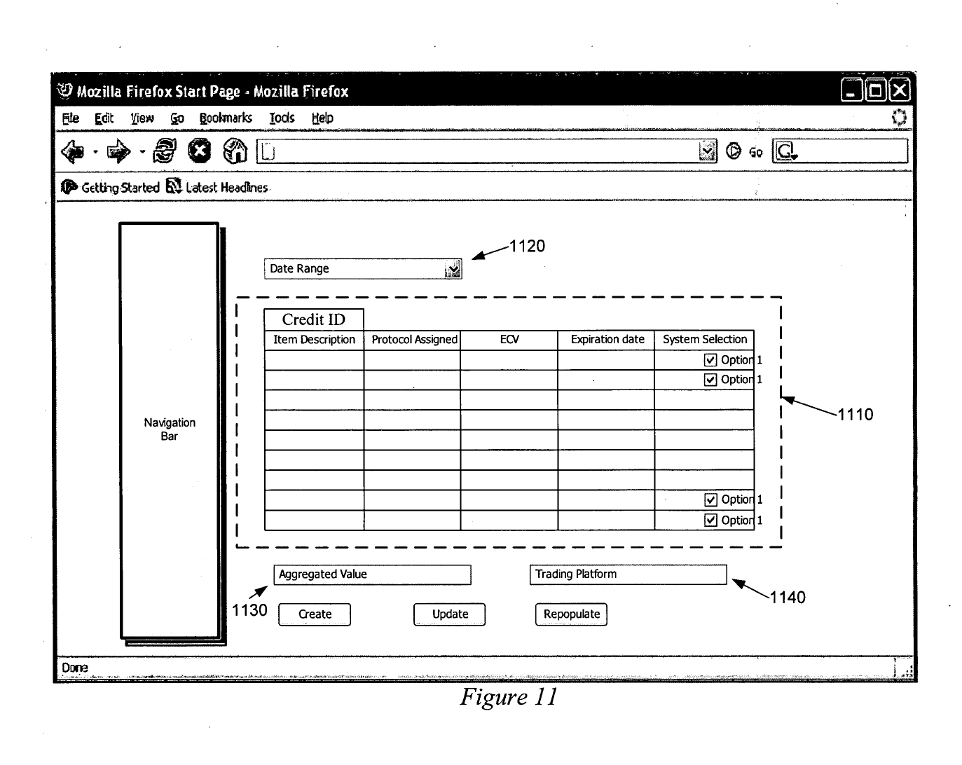

FIG. 11 presents an exemplary bundling interface that allows various entities the ability to view the individual items comprising a credit block or an issued credit. The fields 1110 provide information as to the particular credit block or issued credit that is being displayed and also the items within the credit block that issued as a credit. As shown in FIG. 11, the fields 1110 provide a description of the item, the protocol used in computing the environmental conservation value of the item, the environmental conservation value, an expiration date that specifies the individual useful life durations for each individual item in the credit block, and a selectable option to remove or insert the item in the credit block.

The useful life of the credit is displayed in field 1120. Some embodiments determine the useful life of the credit by selecting the earliest expiration date of an item within the credit block. Specifically, a credit is no longer valid when any item within the credit block used to issue the credit useful expires. Accordingly, the useful life of the credit can be determined by sorting the expiration date field of each item within the credit block.

Fields 1130 and 1140 as shown specify the aggregate environmental conservation value of the credit block or credit as a whole and the trading platform on which the credit is currently listed for trading. Moreover, the display of FIG. 11 can be adapted to present all registered items for a particular user. For instance, the credit ID field may be included within each row of the table to indicate the different credit blocks that the different items are contained within.

While the interface presented in FIG. 11 provides users and system administrators the ability to oversee the allocation of items within credit blocks, some embodiments perform the bundling functionality and updating of credit blocks automatically and transparently from the user. In this automated fashion, some embodiments continually monitor and track credits for validity by periodically reviewing and updating all the components associated with the credit.

In some other exchanges, when the lifespan of a credit is exceeded, the entire credit is retired and removed from the exchange system. However, since the credits of some embodiments include bundled components with multiple environmental conservation items, each item with a particular expiration date, the credits of such embodiments can have a perpetual duration. Rather than retire the entire credit, some embodiments only retire those components within the credit block that have exceeded their useful lifespan and automatically replace the expired component with an “open” or unused and valid component that already exits within the system but is yet made part of a credit block.

Some embodiments therefore retain the remainder of the unexpired items remain within the credit block. Some such embodiments then fill the environmental conservation value gap left by the expired item by adding one or more new items into the credit block where the environmental conservation value for the one or more new items is sufficient to replace the environmental conservation value lost by removing the expired item. The credit block then issues as a credit to be traded within the exchange system. Accordingly, items within the credit block that have yet to expire are reused until their expiration occurs. Alternatively, some embodiments retire the expired item and unbundle the remaining unused and valid components into an “open” pool where they may be rebundled with other unused and valid components to form a new credit.

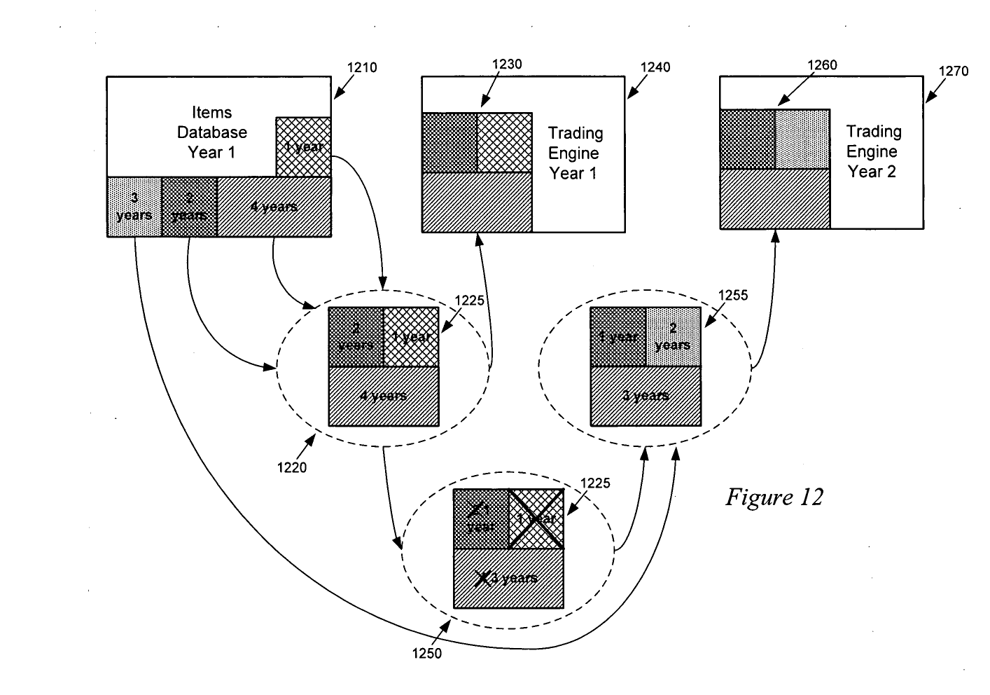

FIG. 12 conceptually illustrates the unbundling and rebundling steps performed by some embodiments of the bundling engine in order to maintain the validity of a credit when one item within a credit block expires. In FIG. 12, an arbitrary starting date is chosen as year 1. At this time, items from the items database 1210 are bundled into a credit block 1220 to issue credit 1230 which is placed within the trading engine 1240 to be traded and sold in year 1. The buyer of credit 1230 acquires the right to offset a specified amount of polluting activities as determined by the environmental conservation value of the credit 1230. However, the rights are limited to a period of one year, because item 1225 used to create the credit 1230 only has a one year lifespan.

The system monitors and tracks some or all issued credits on specified dates or based on specified triggering events. The specified dates may include the one year date from which the credit was issued or can specify some other time period such as the first of every month. Moreover, because the credits include items with different registration dates, some embodiments of the invention monitor the individual items on specified dates rather then check all the items within an issued credit at some time period. For example, the date in which a single item was registered is recorded and then every year on that date that particular item is validated.

In FIG. 12, the system monitors the issued credits one year after they have been issued. Accordingly, at year two, credit 1230 and the items used to issue the credit are reevaluated for validity. The bundling engine checks the items within the credit block 1220 at year two, which is depicted as the credit block 1250. The bundling engine updates the expiration dates of the items in the credit block 1250 and removes any expired items. The component 1225 that had only one useful year remaining at year 1 is retired from the credit block 1250 at year 2 by the bundling engine. A search is then made into the items database to locate a valid replacement 1255 with a sufficient environmental conservation value so as to replace the expired component 1225 without affecting the aggregated environmental conservation value of the credit block as a whole.

After the replacement item 1255 is located and inserted into the credit block 1250, the credit 1230 is reissued in year two as credit 1260. The second year credit 1260 is placed within the trading engine 1270 where it is traded and sold in year two. A similar process occurs as each item expires. At the time of expiration the item is replaced and the credit continues to reissue year after year.

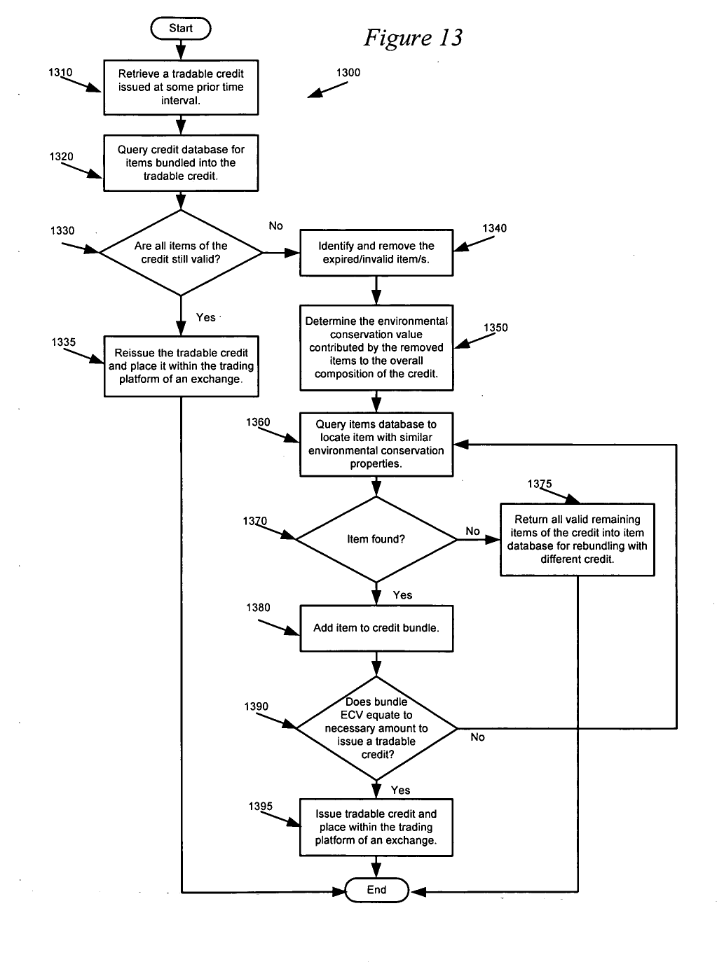

FIG. 13 presents a process 1300 that conceptually illustrates several operations performed performed by the expiration monitor and rebundling module of the bundling engine for the unbundling and rebundling credits. The process begins by retrieving (at 1310) a credit that has been issued at some prior interval. The process queries the credit database (at 1320). By searching the credit database, the process retrieves information as to the items used in creating the credit block that issued as a credit. The process makes a determination (at 1330) as to whether each item still has a useful lifespan. If all such items have at least one full remaining term before expiring, the process reissues (at 1335) the credit and the process ends.

Any items identified as having exceeded or having reached the end of their useful life are removed (at 1340) from the bundled credit. The process then computes (at 1350) the environmental conservation value of all such expired items. This value determines the amount that must be replaced before the credit can be reissued for another term, otherwise the remainder of the credit bundle will have to be unbundled and returned to the “open pool” of items. The process performs a query (at 1360) into the items database to search for an available registered but unassociated item. If such an item is found (at 1370), the process bundles (at 1380) the item with the rest of the credit. If no such replacement item is available (at 1370) within the items database, then the process unbundles (at 1375) the remainder of the credit block, returns the items to the items database for subsequent bundling in another credit block, and the process is again performed at some later time when additional items are available for bundling.

In some embodiments, 1360-1380 may require multiple iterations until a sufficient amount of items are located within the items database where the sum of the environmental conservation values of such items provides the credit bundle with the required environmental conservation value for issuing a credit. Therefore, the process checks (at 1390) the aggregate environmental conservation value of the credit bundle after the replacement item is added at step 1380. If the environmental conservation value is deficient for issuing a credit, then the process again searches (at 1360) the items database for another replacement item. Otherwise, the process issues (at 1395) a credit and all items used in the credit bundle are so marked within the items database so as to not be used in bundling with other credit bundles, assuming the entire environmental conservation value computed for each item used within the credit block is fully allocated to the particular credit block. Should the environmental conservation value of the newly bundled item exceed that of what is needed, the remainder of the value can be bundled with a different credit block.

While the description of FIG. 13 described retrieving a credit and performing monitoring of the items based on each issued credit, it should be apparent to one of ordinary skill in the art that the process of FIG. 13 can be adapted to retrieve only the individual items as opposed to the entire issued credit. In this manner, the retrieved items are monitored for validity and if an item is found to have expired, then the credit to which the item is a component of is retrieved. In this manner, the credit and its components need not be retrieved until a component is found to have expired.

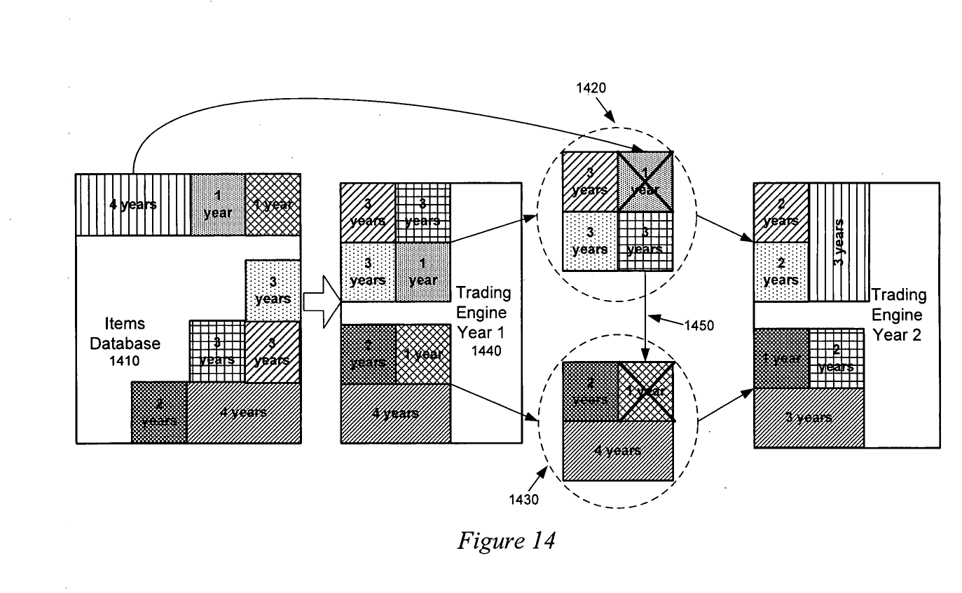

Further functionality of the bundling engine of some embodiments is described in FIG. 14. FIG. 14 illustrates the interchangeability of items within credit blocks or credits. From the items database 1410, the bundling engine creates credits 1420 and 1430 that are issued and placed within the trading engine 1440 to be sold and traded in year 1. At year 2, both credits 1420 and 1430 include items that must be removed as the useful lifespan of the items has expired. Therefore, by using the process described above with reference to FIG. 13 or some other bundling process, the expired items are removed and replaced. However, the bundling engine replaces the expired item of credit 1430 by using an item 1450 that was previously included within credit 1420.

When the credits 1420 and 1430 reissue in year 2, they may include items that were components of other credits in previous years. In this way, a larger pool of available items for creating the credit blocks is made available and the credits are bundled in a more efficient manner. It should be apparent to one of ordinary skill in the art that credit blocks can be formed using a variety of criteria. For example, some embodiments bundle items of uniform lifecycles so that monitoring need only be performed on a credit per credit basis as all items within a certain credit have the same lifespan. Moreover, by monitoring the useful lifecycles for individual items and controlling the grouping of what items are placed into which credit blocks, some embodiments are able to issue credits with useful lifecycles of a given duration. For instance, some embodiments bundle items with a minimum five year useful life in order to issue and sell a credit with a five year useful life to users requesting credits having a five year useful life, whereas buyers wishing to purchase a credit with only a two year useful life can be provided with a credit generated from items with at least one two year useful lifespan.

C. Individualized Bundling

Some embodiments adapt the bundling functionality to allow registrants to directly receive a benefit from their own registered amounts of environmental conservation without issuing credits based on the registered amounts of environmental conservation. Specifically, users receive an environmental conservation value for each item that they register. Rather than bundle these items with other items of other users, some embodiments bundle all environmental conservation values associated with a particular registrant into the user's account for subsequent offsetting by the user. The user may thus offset some polluting activity without having to purchase credits. Such functionality further lets users regulate their own carbon footprint.

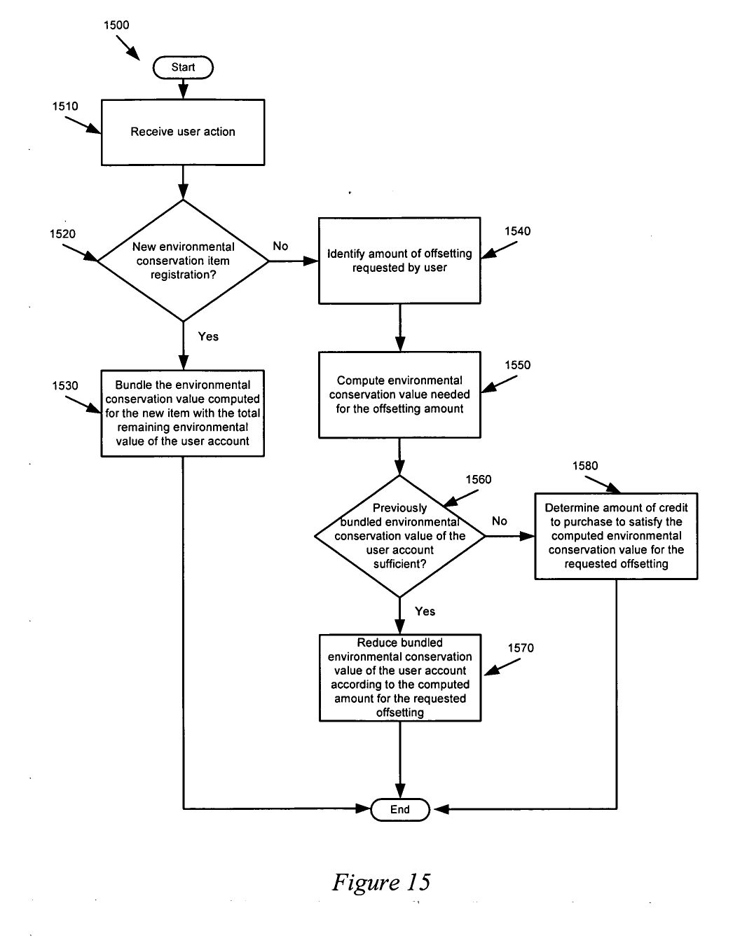

FIG. 15 presents a process 1500 performed by a pricing engine module of the bundling engine to provide the individualized bundling operations of some embodiments. The process 1500 begins by receiving (at 1510) a user action. In some embodiments, the user action includes registration of a new item or a request to offset some amount of pollution resulting from some activity of the user. Therefore, the process determines (at 1520) if the user action specifies the registration of new environmental conservation item. If so, the process receives the registered item and the computed amount of environmental conservation resulting from the item. The process bundles (at 1530) the computed environmental conservation value with a previously registered total environmental conservation value in the user account and the process ends. In this manner, individualized bundled environmental conservation values for each user are stored within some embodiments.

The individually bundled environmental conservation value of the user can be used to offset subsequent polluting activities of the user. Therefore, if the user action specifies offsetting a particular activity, the process identifies (at 1540) an amount of offsetting (e.g., ½ ton of CO2 emissions) requested by the user. The corresponding environmental conservation value for the requested amount is computed (at 1550). The process then determines (at 1560) whether the user has bundled a sufficient environmental conservation value from previous item registrations such that the user is able to fully offset his/her polluting activities.

If the user account contains a sufficient environmental conservation value, then the computed environmental conservation value for offsetting the polluting activity is reduced (at 1570) from the total individually bundled value and the user's polluting activities are considered environmentally (e.g., carbon) neutral. Some embodiments provide such users with certifications of their environmentally neutral activities. Otherwise, the user is not environmentally neutral based on previous environmental conservation items or environmental conservation activities and the user will be required to purchase some portion of a credit or an entire credit to achieve environmental neutrality. Therefore, the process computes (at 1580) the amount of a credit that the buyer must purchase to achieve environmental neutrality and the user then has the option to purchase the specified amount. Users are able to purchase only fractional amount of credits using the buyer bundling functionality described in subsection D) below.

D. Bundling of Buyers

While bundling thus far has been described with reference to a class of item registrants or sellers of credits, the same techniques are applicable to a class of buyers. As stated above, the credits of some embodiments represent standardized or pre-determined environmental conservation values. A buyer who purchases one such credit can use the credit and its associated environmental conservation value to offset the buyer's polluting activities. However, some buyers require only a fraction of the pollution offsetting afforded by an environmental conservation credit (e.g., ½ ton of CO2). Therefore, purchasing an entire credit for some buyers is excessive, wasteful, and might dissuade such potential buyers from participating in the environmental commodities exchange.

As one example, small manufacturers and other such entities may be assigned a quota of pollution allowance in the amount of ½ ton of CO2 emissions per year. If the small manufacturer exceeds the quota by producing ¾ ton of CO2 emissions, it will either have to pay a regulatory fine for the extra ¼ ton of CO2 emissions produced in excess of the assigned quota or purchase credits to offset the excess ¼ ton of CO2 emissions. Typically, credits represent one ton worth of CO2 emissions and thus the buyer would have to pay four times what is actually needed if the buyer was to engage in the environmental commodities exchange and purchase a credit therein.

To facilitate small buyer participation, some embodiments of the invention permit buyers the ability to purchase only a percentage of a credit by bundling several such buyers into a buyer block so that the aggregate of all buyers within the buyer block exhausts the full environmental or pollution offsetting potential of the credit. In this manner, the purchasing power of the buyer block as a whole equates to that of other larger scale buyers that participate in the environmental commodities exchange. Moreover, the cost for purchasing the credit is distributed amongst the several entities and in proportion to their desired participation in the purchase of the credit.

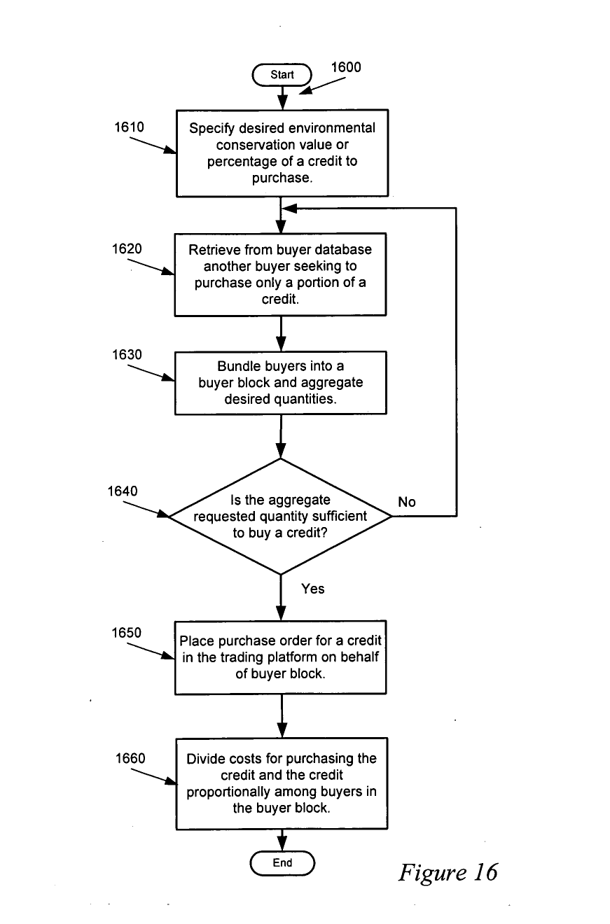

FIG. 16 presents a process 1600 that conceptually illustrates several operations performed for bundling buyers into buyer blocks to purchase credits of uniform or standard sizes. The process 1600 begins when a buyer specifies (at 1610) a desired environmental conservation value or a percentage of a credit that he/she wishes to purchase using a registration interface provided by some embodiments. Once entered into interface, the request is submitted to a buyer database where it is stored. The process then queries a buyer database to locate (at 1620) at least one other buyer requesting to purchase only a fraction of a credit. If the process locates (at 1620) such a buyer, the process bundles (at 1630) the buyer with the original requester into a buyer block. The amount or percentage of a credit requested by each buyer in the block is then aggregated to derive a total value for the buyer block. The process makes a determination (at 1640) as to whether the sum of the requests of the buyer block is sufficient for purchasing an entire credit.

If the sum of the requests within the buyer block falls short of what is needed to purchase a credit, the process returns to 1620 and a subsequent search is made into the buyer database to locate at least one other buyer requesting to purchase only a fraction of a credit and to place such a buyer within the buyer block. This process continues until the sum of the requests in the buyer block is sufficient to purchase a credit. In some embodiments, the determination for purchasing a credit is made when the sum of the requests of the buyer block equates to 100% of a credit or specifies the same environmental conservation value as that found within a credit. Some embodiments purchase the credit so long as the sum of the requests of the buyer block falls within some threshold of the 100% request for a credit or some acceptable range of requested environmental conservation values (e.g., when at least 95% percent of the credit is allocated to the buyer block).

Once the sum of the requests is determined to be sufficient, the process places (at 1650) a purchase request for a credit. The purchase request is made on behalf of the buyers of the buyer block. Therefore, some embodiments use an identifier or associate a name to the buyer block and purchase the credit using the identifier or name.

The cost for purchasing the credit is distributed (at 1660) in proportion to the requested share of the credit by each buyer and the process ends. A buyer requesting one half of the pollution offsetting afforded by a purchased credit will thus have to pay for one half of the cost in purchasing the credit. In this manner, a buyer only pays for what he uses and therefore, it is more likely that small buyers and other potential buyers will participate within the environmental commodities exchange. In some embodiments, the buyers are charged a nominal fee for the facilitation of such services.

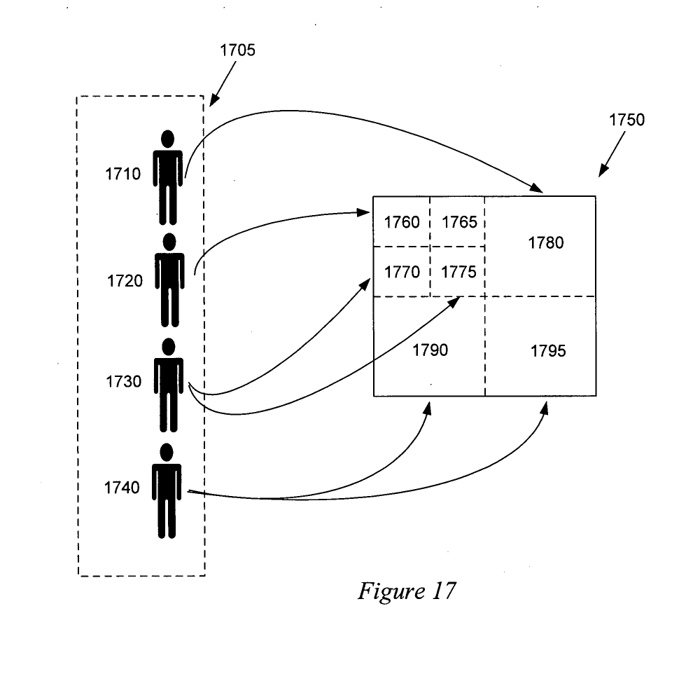

FIG. 17 conceptually illustrates the distribution and allocation of a credit 1750 to a buyer block 1705 in accordance with some embodiments of the invention. In FIG. 17, the buyer block 1705 includes four entities 1710-1740. In some embodiments, the buyers of the buyer block 1705 include individuals, small manufacturers, large manufacturers, and other entities. Together the four entities 1710-1740 have specified a sufficient amount or percentage of a credit 1750 to issue a purchase order within the trading platform for the credit 1750. Specifically, buyer 1710 requested ¼ of a credit 1750, buyer 1720 requested 1/16 of the credit 1750, buyer 1730 requested ⅛ of the credit 1750, and buyer 1740 request ½ of the credit 1750. The sum of the requests of the buyer block 1705 equates to 15/16 of the credit 1750 which in some embodiments is sufficient to place a purchase order on behalf of the buyer block 1705.

Once the credit 1750 is purchased on behalf of the buyer block 1705, each buyer 1710-1740 will be required to pay in similar proportions. However, because 1/16 of the credit was unspecified, the cost of this portion will be distributed amongst all buyers 1710-1740 of the buyer block 1705. Therefore, buyer 1710 pays in addition to ¼ of the total cost for purchasing the credit 1750, a sum in the amount of ¼ of 1/16 of the total cost. Buyer 1720 pays 1/16 of the total cost and an additional 1/16 of 1/16 of the total cost for the unrequested portion of the credit 1750. Similarly, buyers 1730 and 1740 pay a proportional additional sum for the unrequested portion of the credit 1750. One of ordinary skill in the art will recognize that buyers may request portions of a credit using various different means and the costs for purchasing the credit can be distributed using various different cost allocation methods.

As specified above, in some embodiments, the requests of the buyers 1710-1740 represent quantifiable amounts of environmental conservation. Accordingly, some credits represent offsetting potential of one ton worth of CO2 emissions. However, it should be apparent to one of ordinary skill in the art that the credit may have alternative environmental offsetting value. For example, some entities may purchase a fraction of a credit to verify that a portion of their energy consumption is derived from clean energy. Moreover, some entities may purchase a fraction of a credit to verify that a portion of the energy they produce is renewable energy. Some embodiments allow for a combination of some or all such environmental offsetting to occur through the same credit purchased on behalf of a credit block.

E. Distributed Bundling

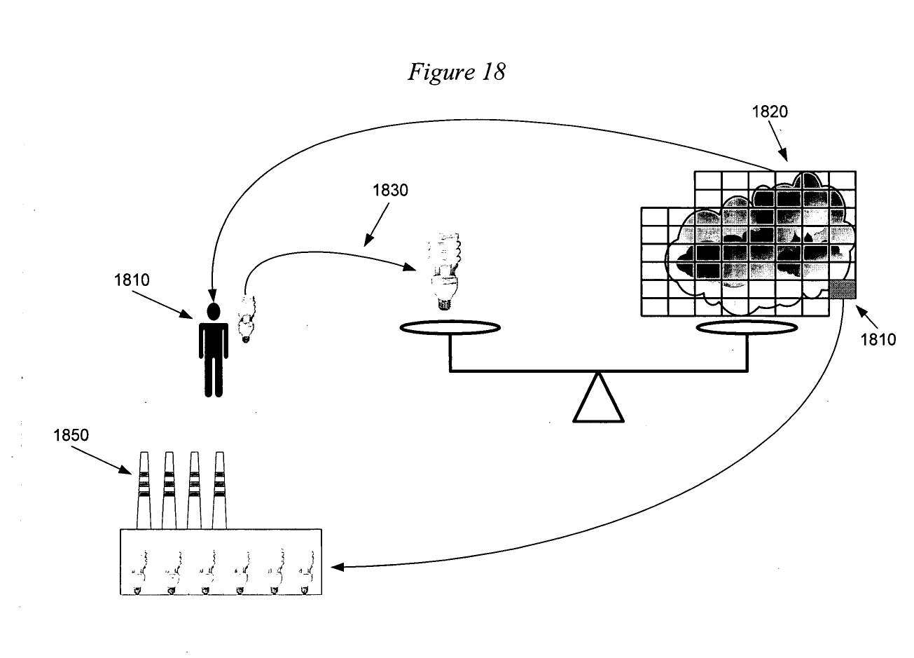

Some embodiments provide incentives for the manufacturers of the environmental conservation items to continue producing such items and to engage within the environmental commodities exchange. In some such embodiments, as illustrated in FIG. 18, a fractional portion 1810 of an environmental conservation value 1820 produced from a registered item 1830 is taken from a registrant 1840. The fractional portion 1810 is instead distributed to a manufacturer 1850 of the item 1830. In this manner, the manufacturer of the environmental conservation items indirectly participates within the commodities exchange through the consumers of its products.

Individually, such fractional shares represent a very miniscule environmental footprint. However, over the aggregate of an entire item's commercial sale life, such fractional shares when totaled together represent a large reduction in the environmental footprint of the manufacturer. For example, in some embodiments an issued credit represents 1 ton of CO2 emissions. For every energy efficient light bulb manufactured by manufacturer X, a registrant who purchases and registers the light bulb with some embodiments of the invention receives an environmental conservation value that equates to 100 pounds of CO2 emissions. From this 100 pounds, the manufacturer receives 1 pound of the 100 pounds of CO2 emissions conservation which equates to 1% of the total registered savings. The registrant still receives 99 pounds or 99% of the registered CO2 emissions conservation. Since there are 2,204 pounds in a metric ton, if the manufacturer X sells 2,204 such light bulbs which are then registered, the manufacturer will accumulate a sufficient aggregate environmental conservation value that equates to a credit (i.e., one ton of CO2 emissions).

In this manner of distributed bundling, both the consumer and the manufacturer benefit from the commodities exchange. The manufacturer can use the credit to offset its own polluting activities or it can place the credit on the trading platform to sell to other manufacturers that need to reduce their environmental footprint. In both instances, the manufacturer derives a compensable benefit from the production and manufacture of environmental conservation items. The consumer's contribution is separately bundled and valued from that of the manufacturer.

Some embodiments provide the manufacturer with a rebate for the fractional shares rather than bundle the fractional shares to issue a credit to the manufacturer. The fractional shares are then stored internally within the system where they are issued as credits and sold within the trading engine of some embodiments.

Though the above discussion has illustrated some embodiments of a computer implemented method for bundling and aggregating environmental conservation items, it should be apparent to one of ordinary skill in the art that the computer implemented method is adaptable to various forms of renewable energy, energy savings, and hazardous waste containing items. Therefore, some embodiments provide a computer implemented interface and method for bundling various forms of items to create aggregated credit blocks.

V. Computer System

Many of the above-described engines, modules, and processes are implemented as software processes that are specified as a set of instructions recorded on a machine readable medium (also referred to as computer readable medium). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc.

In this specification, the term “software” is meant in its broadest sense. It can include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention.

In some embodiments, the various engines and modules described herein represent physical hardware devices that implement the functionality associated with each of the enumerated engines, modules, and processes. It should therefore be apparent to one of ordinary skill in the art that some such engines, modules, or processes are conceptually illustrated as automated machine processes executed without user interaction. However, in some embodiments, some such engines, modules, or processes may be different technical implementations such that they are implemented using a combination of automated and manual processes.

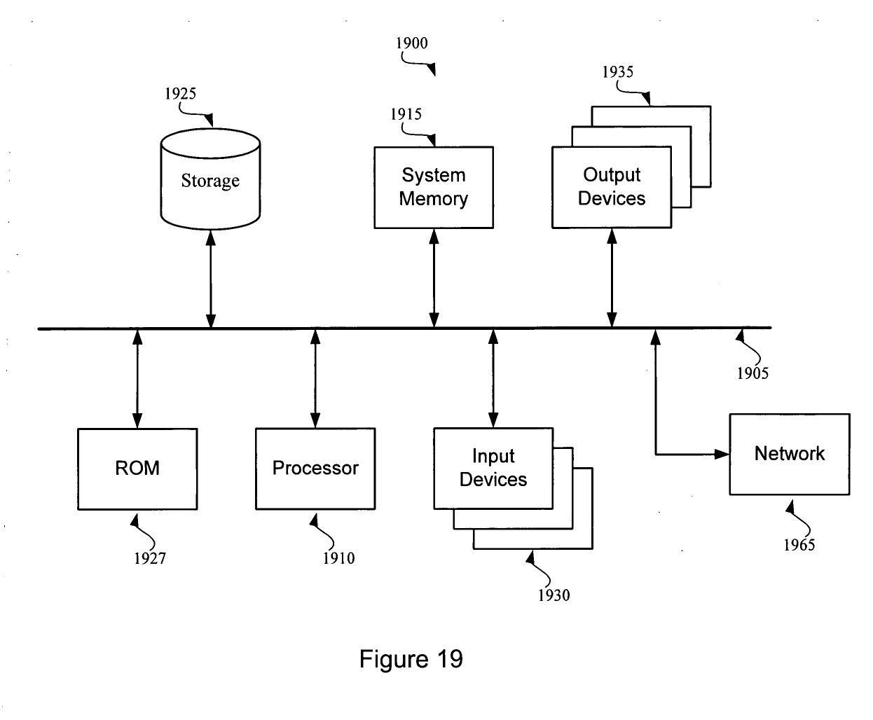

FIG. 19 conceptually illustrates a computer system 1900 with which some embodiments of the invention are implemented. Specifically, the computer system 1900 is for executing the various processes described herein or for illustrating the various modules that comprise the hardware devices used to implement the functionality described herein.

The computer system 1900 includes a bus 1905, a processor 1910, a system memory 1915, a read-only memory 1920, a permanent storage device 1925, input devices 1930, and output devices 1935. The bus 1905 collectively represents all system, peripheral, and chipset buses that support communication among internal devices of the computer system 1900. For instance, the bus 1905 communicatively connects the processor 1910 with the read-only memory 1920, the system memory 1915, and the permanent storage device 1925.

From these various memory units, the processor 1910 retrieves instructions to execute and data to process in order to execute the processes of the invention. In some embodiments the processor comprises a Field Programmable Gate Array (FPGA), an ASIC, or various other electronic modules for executing instructions. The read-only-memory (ROM) 1920 stores static data and instructions that are needed by the processor 1910 and other modules of the computer system. The permanent storage device 1925, on the other hand, is a read-and-write memory device. This device is a non-volatile memory unit that stores instruction and data even when the computer system 1900 is off. Some embodiments of the invention use a mass-storage device (such as a magnetic or optical disk and its corresponding disk drive) as the permanent storage device 1925. Some embodiments use one or more removable storage devices (flash memory card or memory stick) as the permanent storage device.

Like the permanent storage device 1925, the system memory 1915 is a read-and-write memory device. However, unlike storage device 1925, the system memory is a volatile read-and-write memory, such as a random access memory. The system memory stores some of the instructions and data that the processor needs at runtime.

Instructions and/or data needed to perform processes of some embodiments are stored in the system memory 1915, the permanent storage device 1925, the read-only memory 1920, or any combination of the three. For example, the various memory units contain instructions for processing multimedia items in accordance with some embodiments. From these various memory units, the processor 1910 retrieves instructions to execute and data to process in order to execute the processes of some embodiments.

The bus 1905 also connects to the input and output devices 1930 and 1935. The input devices enable the user to communicate information and select commands to the computer system. The input devices 1930 include alphanumeric keyboards and cursor-controllers. The output devices 1935 display images generated by the computer system. The output devices include printers and display devices, such as cathode ray tubes (CRT) or liquid crystal displays (LCD). Such displays can be used to view the multi-server control panel of some embodiments of the invention. Finally, as shown in FIG. 19, bus 1905 also couples computer 1900 to a network 1965 through a network adapter (not shown). In this manner, the computer can be a part of a network of computers (such as a local area network (“LAN”), a wide area network (“WAN”), or an Intranet) or a network of networks (such as the Internet).

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated.

We claim:

1. A method comprising:
a) providing an interface for specifying an item producing a quantifiable amount of environmental conservation; and
b) providing a bundling engine (i) for determining that the quantifiable amount of environmental conservation associated with the item is insufficient to issue a tradable commodity, and (ii) for issuing a tradable commodity by grouping the item with at least one other item with an insufficient quantifiable amount of environmental conservation such that the total quantifiable amount of environmental conservation for the group of items meets a specified amount of environmental conservation for issuing the tradable commodity.

2. The method of claim 1, wherein the bundling engine is further for computing an amount of environmental conservation resulting from use of the item prior to determining that the quantifiable amount is insufficient.

3. The method of claim 1, wherein providing the bundling engine for determining that the quantifiable amount of environmental conservation associated with the item is insufficient comprises comparing the amount associated with the item to a predefined amount of environmental conservation needed to issue a commodity.

4. The method of claim 3, wherein the predefined amount of environmental conservation comprises one ton of reduced carbon dioxide emissions.

5. The method of claim 1, wherein providing the bundling engine for determining that the quantifiable amount of environmental conservation associated with the item is insufficient comprises determining an amount of the insufficiency.

6. The method of claim 5, wherein grouping the item with at least one other item comprises identifying the at least one other item, wherein the total amount of environmental conservation for the at least one other item fulfills the insufficiency.

7. The method of claim 1, wherein the amount of environmental conservation associated with an item comprises an amount of emissions reductions, energy conservation, properly disposed of hazardous materials, or newly generated renewable energy resulting from the use of the item.

8. The method of claim 1, wherein the amount of environmental conservation associated with the item is computed based on an amount of environmental conservation realized by using said item to replace a particular lesser efficient analog item.

9. The method of claim 1, wherein the items within the group comprise items specifying a same type of environmental conservation.

10. The method of claim 1, wherein the items within the group comprise items specifying a different type of environmental conservation.

11. The method of claim 1, wherein the items within the group each produce different amounts of environmental conservation.

12. A method comprising:
a) providing an interface for receiving a plurality of items, wherein each item in the plurality of items has an associated quantifiable amount of environmental conservation; and
b) providing a bundling engine for issuing a tradable environmental commodity by grouping a set of items from the plurality of items, wherein the sum of the quantifiable amounts of environment conservation associated with the set of items is equal to or greater than a predetermined quantifiable amount for issuing a tradable commodity.

13. The method of claim 12 further comprising computing for each item an amount of environmental conservation produced by the item.

14. The method of claim 12, wherein providing the bundling engine for issuing a tradable environmental commodity comprises issuing a first tradable commodity by grouping a first set of items and issuing a second tradable commodity by grouping a second set of items.

15. The method of claim 14, wherein the first and second sets of items comprise at least one of the same particular item, wherein a first portion of the amount of environmental conservation associated with the particular item is used to issue the first tradable commodity and a second portion of the amount of environmental conservation associated with the particular item is used to issue the second tradable commodity, wherein the first and second portions do not overlap.

16. The method of claim 14, wherein the items issuing as the first tradable commodity produce a first type of environmental conservation and the items issuing as the second tradable commodity produce a second type of environmental conservation.

17. The method of claim 12, wherein an item comprises a particular environmental conservation product that is more environmentally friendly than an analog product being replaced by the particular product.

18. The method of claim 12, wherein an item comprises a particular environmental conservation project, said project comprising a process for reducing an environmental pollutant.

19. The method of claim 12, wherein an item comprises a particular environmental conservation technology without an existing analog that provides environmental conservation.

20. A computer readable medium storing a computer program for execution by at least one processor, the computer program comprising sets of instructions for:
a) receiving an item producing a quantifiable amount of environmental conservation;
b) determining that the quantifiable amount of environmental conservation associated with the item is insufficient to issue a tradable commodity; and
c) issuing a tradable commodity by grouping the item with at least one other item with an insufficient quantifiable amount of environmental conservation such that the total quantifiable amount of environmental conservation for the group of items meets a specified amount of environmental conservation for issuing the tradable commodity.
